(19) United States
(12) Patent Application Publication
(10) Pub. No.: US 2024/0280545 A1
(43) Pub. Date: Aug. 22, 2024

(54) APPLICATIONS OF THE WAVELET SYNCHROSQUEEZED TRANSFORM FOR ULTRASONIC INSPECTIONS: QUANTIFYING LAYER HEIGHT AND VISUALIZING MISSING EXTRUDATES IN MATERIAL EXTRUSION PRINTED SAMPLES AND VISUALIZING WRINKLES IN CARBON FIBER LAMINATES

(71) Applicant: BAYLOR UNIVERSITY, Waco, TX (US)

(72) Inventors: Luke W. Battershell, Waco, TX (US); David A. Jack, Waco, TX (US); Trevor Fleck, Waco, TX (US)

(73) Assignee: BAYLOR UNIVERSITY, Waco, TX (US)

(21) Appl. No.: 18/444,567

(22) Filed: Feb. 16, 2024

Related U.S. Application Data
(60) Provisional application No. 63/446,602, filed on Feb. 17, 2023.

(51) Int. Cl. G01N 29/46; G01B 17/02; G01N 15/08; G01N 29/04

(52) U.S. Cl. CPC G01N 29/46; G01B 17/02; G01N 15/088; G01N 29/043; G01N 2291/0231

(57) ABSTRACT

A method for ultrasonic inspection of fused filament fabrication (FFF) manufactured samples and of carbon fiber reinforced polymer (CFRP) laminates is disclosed that includes performing a time-frequency transforms including the short-time Fourier transform (STFT) and the wavelet synchrosqueezed transform (WSST), inspecting features in FFF manufactured samples for porosity, layer height and missing extrudate and visualizing CFRP laminate wrinkle.

### CROSS REFERENCE TO RELATED APPLICATIONS

This application claims priority to and benefit of U.S. 63/446,602, filed Feb. 17, 2023, which is hereby incorporated by reference for all purposes as if set forth herein in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

Characterizing materials is a complex process, and there are many unrecognized problems that prevent it from being as effective as needed.

### SUMMARY OF THE INVENTION

A method for ultrasonic inspection is disclosed that includes generating ultrasonic inspection data of a component. A short-time Fourier transform (STFT) is performed on the ultrasonic inspection data to generate STFT data. A wavelet synchrosqueezed transform (WSST) is performed on the ultrasonic inspection data to generate WSST data. The STFT data and WSST data are visualized on a user interface. User-entered control data are received to accept or reject the component based on the STFT data and the WSST data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

FIG. 1, which is a visualization of missing extrudate that is configured to allow a user to accept or reject a scanned component, in accordance with an example embodiment of the present disclosure;

FIG. 2 is a visualization of a change in porosity that is configured to allow a user to accept or reject a scanned component, in accordance with an example embodiment of the present disclosure;

FIG. 3 is a visualization of a change exponential coefficient as a function of porosity that is configured to allow a user to accept or reject a scanned component, in accordance with an example embodiment of the present disclosure;

FIG. 4 is a visualization of layer height as a function of depth that is configured to allow a user to accept or reject a scanned component, in accordance with an example embodiment of the present disclosure;

FIG. 5 is a visualization of layer height as a function of depth that is configured to allow a user to accept or reject a scanned component, in accordance with an example embodiment of the present disclosure;

FIG. 6 is a visualization of geometry of a wrinkle that is configured to allow a used to accept or reject a scanned component, in accordance with an example embodiment of the present disclosure;

FIG. 7 is a diagram of a process for analyzing ultrasound data, in accordance with an example embodiment of the present disclosure;

FIG. 8 is a diagram of a system for ultrasound data analysis, in accordance with an example embodiment of the present disclosure;

FIG. 9 is a diagram of an algorithm for ultrasound data analysis for porosity visualization, in accordance with an example embodiment of the present disclosure;

FIG. 10 is a diagram of an algorithm for ultrasound data analysis for layer height visualization, in accordance with an example embodiment of the present disclosure;

FIG. 11 is a diagram of an algorithm for ultrasound data analysis for visualization of missing extrudates, multiple layers and wrinkles, in accordance with an example embodiment of the present disclosure; and

FIG. 12 is a diagram of an algorithm for ultrasound data analysis for visualization of porosity in separate layers, in accordance with an example embodiment of the present disclosure.

### DETAILED DESCRIPTION OF THE DISCLOSURE

In the description that follows, like parts are marked throughout the specification and drawings with the same reference numerals, respectively. The drawing figures might not be to scale and certain components can be shown in generalized or schematic form and identified by commercial designations in the interest of clarity and conciseness.

The disclosure generally relates to a propeller with low noise and high efficiency. More specifically, the disclosure relates to a propeller designed with a blade curvature that converges into a tip zone prior to the tip that is unloaded, that is, produces negligible lift.

Additively manufactured components allow a designer to take advantage of increased freedom of design. Material extrusion, such as fused filament fabrication (FFF), has been used for additive manufacturing currently used in industry but is not fully understood. One potential use of additive manufacturing in the aerospace industry is for rapid prototyping. To move from that to functional use, additively manufactured components need to be inspectable. This disclosure provides inspection methods for material extrusion printed components, and introduces the use of the wavelet synchrosqueezed transform (WSST) in the analysis of ultrasonic testing (UT) inspection data. The disclosed systems and methods use the WSST to quantify layer height and visualize missing extrudate. The methods for quantifying layer height are extended to the visualization of wrinkles in carbon fiber laminates which are commonly used in the aerospace industry.

UT is a common nondestructive testing technique used widely in the aerospace industry. Currently, most analysis methods associated with UT are based in either the time domain or the frequency domain based. The present disclosure recognizes that UT as it has been used for detecting and characterizing defects in complex material systems such as additively manufactured components and fiber reinforced laminates (fiberglass reinforced laminates, carbon fiber reinforced polymer (CFRP) laminates and other suitable laminates), and can be used for the additional systems and processes disclosed herein.

The use of additive manufacturing is still in its infancy. For example, the use of additive manufacturing methods such as FFF has been primarily used for rapid prototyping and not for structural components. While there is a rapidly growing understanding of the mechanical properties of FFF manufactured components, there is still a need for inspection techniques that can identify and characterize features and defects in FFF printed components. Therefore, improving the inspectability of FFF manufactured components is one of the goals of the present disclosure.

CFRP laminates can be used in the aerospace industry. Out-of-plane wrinkles are of concern due to their impact on the performance of the laminate. Nondestructive techniques have been developed for identifying wrinkles using time domain analysis, but enhanced methods are needed with an improved accuracy. Introducing a new technique for the visualization of wrinkles is another goal of the present disclosure.

The present disclosure takes advantage of time-frequency transforms, including the short-time Fourier transform (STFT), the continuous wavelet transform (CWT), and the WSST to inspect FFF manufactured components and visualize out-of-plane wrinkles in CFRP laminates. Features such as inter-bead porosity, layer height, and missing extrudate can be explored in the analysis of UT inspection of FFF components. The use of the WSST is introduced for the purpose of tracking the dominant frequency of an ultrasonic signal through the depth of a part. The frequency can then be used to quantify layer height and visualize missing extrudates. The layer height as a function of depth that results from the proposed method is then compared to results from a computed tomography (CT) scan of a FFF manufactured sample. Using the same technique to quantify layer height in CFRP laminates also makes the visualization of wrinkles possible.

The technical and scientific features and objectives of the present disclosure include the following:

The use of the STFT for the detection of inter-bead porosity in FFF manufactured samples with differing porosity contents without the need for a backwall signal

The quantification of layer height in FFF manufactured samples using a novel analysis method that utilizes the WSST to track the dominant frequency of an ultrasonic signal with high resolution

The visualization of missing extrudates in FFF manufactured samples

The visualization of multiple layers in a CFRP laminate containing out-of-plane wrinkles

UT and current applications of UT for inspection of FFF manufactured components is provided to show how that existing ground work is applied to the present disclosure, in order to analyze the effect features and defects in FFF manufactured components, including inter-bead porosity, layer height, and missing extrudate, have on the overall performance of a component, in accordance with the teachings of the present disclosure. Current methods for the inspection of out-of-plane wrinkles within CFRP laminates are also discussed that are applicable to present disclosure, including a discussion on the reduction of the mechanical properties of CFRP laminates caused by the presence of a wrinkle. The time-frequency transforms used in the present disclosure and a study of the current applications found for the WSST in the analysis of ultrasonic testing as they relate to the present disclosure are also provided.

The present disclosure also presents materials, manufacturing methods, and experimental setups used. An introduction to the FFF printer used and how it can be used to produce the samples inspected for this disclosure is given, as well as a manufacturing method that can be used for manufacturing the CFRP laminate wrinkle specimens. An ultrasonic immersion scanning system is described along with the techniques used for scanning the samples in accordance with this disclosure. A method for measuring the density of FFF printed samples for the purpose of measuring porosity is disclosed, as is a process for measuring the layer height using the CT scan of a FFF printed sample.

Scanning methods and analysis methods used for investigating porosity, measuring layer height, and visualizing missing extrudates in FFF manufactured components and visualizing wrinkles in CFRP laminates are also disclosed. Scanning methods used for both FFF manufactured samples and CFRP laminates are laid out, followed by general ultrasonic analysis steps that can be applied to all data sets. A method for using the STFT for characterizing porosity is disclosed. The general analysis steps involving the WSST that are used for layer height, missing extrudate, and wrinkle samples is described, followed by the introduction of a new method for quantifying the layer height in an FFF manufactured sample using the resulting frequency information. Then a discussion of a method for visualization of missing extrudates is presented, ending with the description of a new visualization method for wrinkles in CFRP laminates.

Example results from the analysis methods are also presented. The example results are from the investigation of inter-bead porosity characterization in FFF manufactured components, as well as results from quantifying the layer height of FFF manufactured components, visualization of missing extrudates in multiple samples and discussion of the wrinkle visualization technique's efficacy.

### UT Related to the Present Disclosure

UT is a non-destructive testing (NDT) method used in many applications. UT systems typically consist of a pulser-receiver, transmitting transducer, receiving transducer, digital oscilloscope, and a computer. The pulser-receiver is responsible for applying a voltage pulse to the transmitting receiver and then amplifying the signal that is received by the receiving transducer. An ultrasonic transducer converts electrical energy to mechanical energy in the form of sound using a piezoelectric crystal. The digital oscilloscope digitizes the signal received by the pulser-receiver and the computer collects the data from the oscilloscope.

One setup that can be used in accordance with the present disclosure is known as pulse-echo setup. In a pulse-echo setup, the transmitting and receiving transducers are both the same physical transducer. This results in the ultrasonic signal being a result of whatever features in the sample reflect the sound wave back to the transducer.

Immersion UT scanning can also or alternatively be used. Immersion UT scanning can be performed by having both the sample and transducer immersed in water. Due to the high frequency of ultrasound, the sound produced by UT transducers typically attenuates very quickly in air, however, water is able to carry the sound much better. As a result, techniques such as immersion scanning are used in the present disclosure to inspect samples with UT.

Both flat front and focused transducers can be used for UT scans. Flat front transducers, as the name suggests, have a flat acoustic lens on the front of the transducer, meaning that the area of the sound beam produced by the transducer is about the same shape of the transducer itself. However, there is beam spread that results in the beam growing wider as it gets further from the transducer. Focused transducers have a curved acoustic lens, for this disclosure the lens is spherical. The curved lens causes the beam to focus on a region in front of the transducer. This effect can be useful for producing high resolution scans of a sample as a small area on the sample can be inspected by the transducer.

### UT for Fused Filament Fabrication

UT can be performed to inspect a component or filament in a variety of stages of the FFF manufacturing process, such as using one transducer, or one set as with phased array, as a pulser and receiver, using two transducers in a through transmission mode with one transducer on either side of the part or in other suitable manners. When using one transducer, the intention is that the transducer produces ultrasonic waves and then portions of the ultrasonic waves reflect at boundaries between differing impedances. Those reflected waves are in turn received by the same transducer. In through transmission, one transducer produces the ultrasonic waves that then travels through the part and to the second transducer.

### Defect Detection and Structural Analysis

In additive manufacturing (AM) associated with this disclosure, there is a need to detect defects and verify the integrity of the structure of an FFF component. Many different UT methods can be used to accomplish this goal. Immersion UT, phased array UT, air-coupled UT, scanning laser UT and other suitable systems and processes can be used for this purpose.

Immersion UT. Immersion UT can be used for inspection of FFF printed components with a variety of features and defects, such as included substrates, such as planar microwave circuits with a 3D printed substrate made of PLA with copper metal circuits attached after the initial printing. A low-cost method for producing planar microwave circuits with more complex and specific structures as is made possible by printing multilayer filters can be provided. Samples with differing circuits and substrate materials can be tested using UT to perform a structural analysis of the samples to verify that the samples were manufactured accurately, using time domain analysis, in the form of c-scans, and frequency analysis. The integrity of the substrate below the copper sheets can be verified and a check for other defects such as fiber misalignment, voids, and changes in the density of the filaments can be made, and is suitable for use in conjunction with the present disclosure.

A UT method for determining the density of a FFF 3D printed part using a 1″ 0.5 MHz transducer has been reported where two samples were produced; both samples had 100% infill and were printed with varying flow rates. One sample was considered a high contrast sample with large steps in density while the other sample was considered low contrast with smaller steps in density. The intention of the study was to determine the ability to determine the density of the sections of the samples using ultrasound.

A test configuration for a lateral scan can include an oscilloscope coupled to a pulser/receiver that is coupled to a transducer and a computer. A 2D translation stage controller is coupled to the computer and a Y/Z translation stage, which is coupled to the transducer. The transducer can be immersed in water in a tank with the test object. In the axial plane, the 2D translation stage controller and Y/Z translation stage can be omitted. For additional details, see Jin, Y., Walker, E., Heo, H., Krokhin, A., Choi, T. Y., & Neogi, A. (2020). Nondestructive ultrasonic evaluation of fused deposition modeling based additively manufactured 3D-printed structures. Smart Materials and Structures, 29(4), 045020, which is hereby incorporated by reference for all purposes as if set forth herein in its entirety.

For the lateral scan, the density can be calculated from a singular a-scan as the ratio of the impedance with the speed of sound in the material or in other suitable manners. The impedance can be calculated as a function of the impedance of DI water and the maximum absolute amplitude values of the emitted pulse, the first reflection of the sample, and the reflection from the back wall of the sample. The lateral scans can produce density contours that show strong differentiations between the different flow rate zones. Both high contrast and low contrast samples can produce results within a 6% error for all regions compared to theoretical densities in the lateral scans. For an axial scan, the density can be calculated slightly differently if there is a reflection at each transition between the respective zones of density. As such, each zone can have its density calculated separately with one singular a-scan. An a-scan for each direction along the print axis of the high contrast sample can be produced and densities of 100%, 60% and 80% flow rate regions or other suitable flow rates can be calculated.

A method for porosity characterization in accordance with this disclosure does not require reflection from the back wall. Through transmission data can be used to detect lack of adhesion and verify the infill pattern and dimensions of through holes.

A process for qualifying or certifying FFF printers using UT on a standardized part can be used to print a described part, which has intentional defects and geometry, to verify the quality of a printer through an inspection of the part. This is another suitable process that can be used in conjunction with the present disclosure.

Phased Array Ultrasonic Testing. Phased array ultrasonic differs from conventional ultrasonic testing as the probe consists of many small transducers arranged in an array rather than having a single transducer. This is another suitable process that can be used in conjunction with the present disclosure.

A 50 MHz phased array probe can be used to inspect tensile bars that are printed with a fused filament fabrication method. All layers of the test specimens can be inspected using the 50 MHz probe in an immersion tank. The high frequency probe can result in high resolution images of most layers of the specimens. Layers closest to the focal point can have the best resolution. On layers with better resolution, it can be possible to see material that dripped from the 3D printer nozzle as it traveled. A cross-sectional view of the CAD drawing compared to the phased array scan of one of the samples can be generated. The resolution can provide a lot of detail to the image. This is another suitable process that can be used in conjunction with the present disclosure.

Defects can be printed into some specimens by way of intentional under-extrusion and it is possible to size the width of the defects within 10% of the designed width. Tensile tests can be performed on the samples to confirm the defect's effect on the mechanical properties of the specimens, and an increase in the size of the defect can decrease the mechanical performance of the specimens. This is another suitable process that can be used in conjunction with the present disclosure.

Continuous glass fiber reinforced composites can be produced using a 3D printer which uses a modified FFF printing process to extrude nylon filament and insert glass fibers at the same time. The composite panels can undergo impact testing and a UT inspection system with a phased array transducer can be used to inspect the resulting damage. This is another suitable process that can be used in conjunction with the present disclosure.

Impact damage can be compared in a variety of composite structures. Using phased array, a delamination 1 mm in depth below the impacted surface can be detected. A phased array can be a useful tool for evaluating internal damage of 3D printed composite materials. This is another suitable process that can be used in conjunction with the present disclosure.

Air-coupled Ultrasound. Air-coupled ultrasound is similar in theory to more traditional ultrasonic systems like immersion, but the frequencies are much lower, and the energies are much higher in order that the ultrasonic waves can travel the short distance through air that is required of these transducers. Due to the use of lower frequencies, smaller defects have the potential to be missed entirely. However, this process results in the removal of the need for an acoustic coupling agent such as water or gel. Air-coupled ultrasound is typically used in a through transmission setup. This is another suitable process that can be used in conjunction with the present disclosure.

Air-coupled ultrasound, thermography, and eddy current for the inspection of FFF printed panels with included defects can be compared. Defects as thin as 0.1 mm can be detectable with the air-coupled ultrasound system. Also, defects of varying shape can be detectable with a clear output. This is another suitable process that can be used in conjunction with the present disclosure.

Sets of FFF manufactured samples made with acrylonitrile butadiene styrene (ABS) can be tested, where a first set of samples is varied in thickness for the purpose of studying ultrasonic wave propagation and attenuation through the parts. A second set can have defects of varying sizes printed into them, such as some that are purely internal and some that have an open face to one side. This is another suitable process that can be used in conjunction with the present disclosure.

Rounds of experiments can be performed, such as where a-scans are obtained for every sample. The drop in amplitude over the thickness of every sample can be recorded. Properties of the interpolated curvature can be attributed to the attenuation of the samples at the specified density. This is another suitable process that can be used in conjunction with the present disclosure.

A second round of experiments can involve performing a c-scan of the samples with printed defects. It was noted that the samples can have differing densities which can affect results of the c-scans. Porosity and dense sections resulting from printing flaws or inclusions should be considered as affecting the integrity of an FFF printed part. This is another suitable process that can be used in conjunction with the present disclosure.

Scanning Laser Ultrasound. Scanning laser ultrasound can use an ultrasonic transducer to excite a part with a single tone ultrasonic signal. A laser Doppler vibrometer (LDV) is placed on the other side of the part and is used to detect the vibration of the part along the face closest to the LDV. LDV's can very quickly scan a surface to measure the vibration across it, making it useful for in-process inspections. This is another suitable process that can be used in conjunction with the present disclosure.

A scanning laser ultrasound system can be used to perform in-process inspection of FFF printed components. An ultrasonic transducer can be attached to the bottom of the build plate. The LDV can be attached to the top of the FFF 3D printer gantry. Using this method, the FOD from the first layer it was applied through the remainder of the print can be detected. Localized heating damage can be detectable. This is another suitable process that can be used in conjunction with the present disclosure.

### Material Property Determination

Ultrasonic testing has been used in other, more traditional, material systems for determining material properties. The same models have been used with FFF printed parts as well. This is another suitable process that can be used in conjunction with the present disclosure.

Generally, determining material properties using ultrasound is based on determining the speed of sound, or wave velocity, in the material. However, not only is the longitudinal wave velocity in every direction needed, but also the transverse wave and quasi longitudinal wave velocities in every direction. The density of the material is also needed, though this is usually assumed constant for these calculations. The wave velocities and density can then be related to values in the stiffness matrix of the material. The values of the stiffness matrix are then related to tensile and shear moduli in every direction and Poisson's ratios in every direction. This is another suitable process that can be used in conjunction with the present disclosure.

Material properties of printed polycarbonate-acrylonitrile butadiene styrene (PC-ABS) samples using an FFF process with both 0° and 0°/90° raster patterns can be investigated using ultrasound and verified with mechanical tests and finite element analysis (FEA). The material properties can first be determined using ultrasonic inspection using the method described previously. In order to get all of the wave velocities needed, special samples with specific geometries can be printed for both raster patterns to allow for casy determination of all of the wave velocities. The densities can also be calculated for the whole experiment with the wave velocity samples. Tensile tests can have results differing from the UT scans. The differences can be attributed to differences in density between the two sample types, the viscoelastic behavior of the material, or due to the differing strain rates of tensile tests compared to ultrasound, with tensile tests having a lower strain rate that ultrasound would produce. The results from experimental and FEA 4-point bend tests and impact hammer tests showed agreement with the results from the UT and tensile test results. This is another suitable process that can be used in conjunction with the present disclosure.

Ultrasound can be used to determine the material properties of FFF printed tensile bars. Tensile samples can be prepared with differing print speeds and layer thicknesses. The change in values for the print speeds and layer thicknesses can result in changes in the measured wave velocities of the samples. Those changes can correspond to differing stiffness matrix values and thus differing material properties. These changes can then be confirmed with tensile tests which offered similar changes to the stiffnesses in the 1 and 2 directions. The change in mechanical performance resulting from the differing print parameters can be of the same trend. This is another suitable process that can be used in conjunction with the present disclosure.

Viscoelastic properties of FFF printed samples made with acrylonitrile butadiene styrene (ABS) using a Dynamic Mechanical Analyzer (DMA) in addition to ultrasonic testing can be determined. The modulus components of the different samples can be found to mostly agree with the UT results. Also, using the attenuation coefficient of the sample along with the wave velocity and frequency of the transducer, the tan delta of the material at 1 MHz can be calculated using ultrasound. However, due to the nature of viscoelastic properties, results from the DMA might not be directly compared to results found using ultrasound as the properties are frequency dependent. This is another suitable process that can be used in conjunction with the present disclosure.

Maps of the bulk, tensile, and shear moduli and density for FFF printed ABS samples can be generated. The moduli and densities can be calculated based on the longitudinal and transverse wave velocities, the attenuation coefficient, and impedance of deionized (DI) water. Samples can be printed which differing nozzle diameters and flow rate changes. The first sample can be produced with a 0.4 mm nozzle and half of the block can be printed at 100% flow rate and the other half at 80% flow rate. The second sample can be produced with a 0.2 mm nozzle and half of the block was printed at 100% flow rate and the other half at 96% flow rate. The samples can be inspected with a pulse echo immersion UT system. A raster scan can be performed and the moduli and densities can be mapped across the scan region. The mapping can make it possible to differentiate the different flow rate regions in the samples. The transverse wave velocities can be found for each region of each sample as a function of the fired angle. As such, the values of the tensile and shear moduli, which depend on the transverse wave velocity, can have multiple maps made for each sample over select incident wave angles. The tensile and shear moduli can change with the incident angle, as it is expected that those values are directionally dependent unlike the bulk modulus and density. However, the added value of the shear velocity in the tensile and shear moduli calculations can make the difference between flow rate regions more evident. This is another suitable process that can be used in conjunction with the present disclosure.

A method for determining the tensile modulus and density for a FFF filament can allow for the filament to be inspected in line with the 3D printer allowing for validation of the filament as it is being fed to the printer. Using an immersion ultrasonic system, the backscattered signal from the filament can be found for the immersed filament. Using that signal, the form function of the filament can be found. The form function that is experimentally derived, along with the theoretical form function of the material, can be used to find the objective function. The objective function in turn can be used with an optimization algorithm to find the tensile modulus and density of the filament. This is another suitable process that can be used in conjunction with the present disclosure.

### Inter-Bead Porosity in Fused Filament Fabrication

Inter-bead porosity is inherent in FFF methods due to the nature of the manufacturing method. As material is extruded layer by layer, the extrudate does not filly fill in the intended volume. Instead, voids are left between the individual deposited rasters where the material does not fill in the small spaces between beads in the same layer and beads of neighboring layers. Inter-bead, or equivalently inter-filament, porosity, or voids, within FFF manufactured components can cause stress concentrations, which generally results in reduced part performance. The presence of inter-bead voids can greatly reduce the tensile strength of a FFF manufactured component. In addition intra-bead voids can occur during manufacturing. These can also cause stress risers, but tend to degrade the overall polymer behavior. This is another suitable process that can be used in conjunction with the present disclosure.

### Layer Height in Fused Filament Fabrication

In FFF, layer height is a print parameter commonly modified to adjust the print times, mechanical properties, resonant frequency, surface roughness, or dimensional accuracy, which are all at odds with each other As layer height affects all of these properties of printed components, it is important to know the layer height to understand final part performance. In general, increasing the layer height decreases print time because increasing the layer height splits the printed geometry into fewer layers, which takes less time to print, but this comes at cost of an increase in the surface roughness.

Layer height can have an effect on many mechanical properties such as ultimate tensile strength, flexural strength, Young's modulus, and toughness. Part of the reason for layer height's effect on mechanical properties is ties to the heating and cooling cycles of the extruded material and its effect on bonding area between layers. Change in layer height affects the rate of cooling and thus can affect the number of thermal related distortions and stress accumulations. Layer height on the bonding area between layers can affect the strength of the sample, and layer height can have an effect on the line width and thus the bond width between layers which in turn affects the ultimate tensile strength and Young's modulus of samples. These are processes that can be used in conjunction with the present disclosure.

While layer height affects mechanical properties, the material selected can determine the specifics of how the layer height affects the mechanical properties. The tensile strength and deformation of samples made of both thermoplastic polyurethane (TPU) and polycarbonate (PC) can vary with layer heights. Layer height can affect the mechanical properties of samples of both materials, but PC can be less sensitive to changes in layer height compared to TPU. This is another suitable process that can be used in conjunction with the present disclosure.

The effect layer height can have on mechanical properties can also change as a result of other print parameters such as infill percentage and line width. The effect layer height has on tensile strength in samples printed from acrylonitrile butadiene styrene (ABS) is dependent on the infill percentage. Layer height may only have an appreciable effect on the ultimate tensile strength when the infill percentage was set to 85% or 90%. Both layer height and line width can have an effect on the mechanical properties of FFF printed samples. The layer height's effect on the mechanical properties can be affected by the line width. This is another suitable process that can be used in conjunction with the present disclosure.

Layer height can affect the quality of the sample in terms of surface roughness and dimensional accuracy. Surface roughness typically decreases as layer height is decreased. However, that is not always the case depending again on other print parameters. Dimensional accuracy is also affected by layer height. Decreasing the layer height can improve both surface roughness and dimensional accuracy. Line width and layer height together an affect surface roughness and dimensional accuracy. This is another suitable process that can be used in conjunction with the present disclosure.

Layer height can affect the vibration properties of a printed sample, specifically its resonant frequency. As layer height increases, the resonant frequency also increases. This is another suitable process that can be used in conjunction with the present disclosure.

Adaptive and variable layer height are techniques that can improve surface finish and remove or decrease stair stepping. Stair stepping is an effect common in 3D printing as the slicer tries to match the input geometry to its best ability, but is limited by the layer height of the print. It is especially noticeable on curved geometries. Adaptive layer height is a technique that changes the layer height layer by layer. As the layer height can be changed to better match the contour of the input geometry, the effect of stair stepping is decreased. Variable layer height changes the layer height dynamically within each layer. This results in layers that are non-planar, but instead change dynamically to best fit the outer contours of the input geometry while improving surface finish and eliminating stair stepping. This is another suitable process that can be used in conjunction with the present disclosure.

Adaptive and variable layer height are not used in this disclosure for sample manufacturing. However, with components made with either of these techniques, the truc layer height would be important to determine when calculating expected mechanical properties of a part. Determining layer height, using a technique such as the one introduced in this disclosure, could be important for samples where the layer height is unknown or there is a need to qualify the proper manufacturing of a component with a designed variation of layer height. And with adaptive or variable layer height samples, future techniques built off of the one introduced in this disclosure could potentially be used to determine the layer height as a function of location in the part. This is another suitable process that can be used in conjunction with the present disclosure.

### Missing Extrudate in Fused Filament Fabrication

In FFF, manufactured parts missing extrudates refer to defects that result from the extruder unintentionally pausing during the print, or an entrapped air bubble in the filament, resulting in a gap in the final part. Missing extrudates can affect the performance of final parts.

The impact that defects such as missing extrudates have on the tensile properties on fused filament fabrication manufactured polylactic acid (PLA) samples can be inspected. It is found that the missing extrudate, regardless of the orientations inspected, can cause a decrease in the tensile strength and in the tensile moduli. A missing extrudate that is transverse to the loading direction has a more severe impact on tensile strength, modulus, and failure strain than a missing extrudate along the loading direction.

Increasing the width of the missing extrudates in the loading direction typically decreased the Young's modulus and tensile strength of the samples. This is another suitable process that can be used in conjunction with the present disclosure.

Missing extrudates can negatively impact the effective elasticity of samples. Missing extrudates in the transverse direction have a more severe effect on tensile strength than missing extrudates in the loading direction. This is another suitable process that can be used in conjunction with the present disclosure.

### Wrinkles in Carbon Fiber Reinforced Polymer Laminates

Out-of-plane wrinkles are defects common to CFRP laminates. Wrinkles can adversely affect the performance of a CFRP laminate. This results in a need for wrinkle detection in CFRP laminates.

Wrinkle geometry can negatively affect the compressive strength of the laminate. Wrinkle metrics of maximum wrinkle angle, wrinkle wavelength, and the extent of the wrinkled region to be of importance in non-destructive testing (NDT) methods. This is another suitable process that can be used in conjunction with the present disclosure.

A micromechanics model can be used for the determination of effective elastic properties in composite laminates with out-of-plane wrinkles. The model can use the geometry of the wrinkle to estimate the effective properties of the laminate. This is another suitable process that can be used in conjunction with the present disclosure.

Out-of-plane wrinkles in CFRP laminates can decrease the tensile strength decreased by up to 3.8% as the waviness of the wrinkle increases, which indicates a minimal effect. The tensile modulus has a low sensitivity to the waviness of the wrinkle, with a maximum decrease of 2.3%. Large waviness ratios can slightly increase the tensile modulus of 0.4%. The compressive strength and compressive modulus can both show a decrease, with a maximum of 33% and 14.4% respectively, as the waviness of the wrinkle is increased. Compressive strength can be affected most by the waviness of the wrinkle. In compressive tests, the common failure modes are delamination and tensile shear failure. Impact strength can increase up to 17.5% with the wrinkle as compared to a flat part, but the higher the waviness, typically the lower the impact strength. This is another suitable process that can be used in conjunction with the present disclosure.

A chosen lamina can be tracked in the ultrasonic signal by tracking the same associated peak in each a-scan of the scan to produce a digital version of the wrinkled layer. That digital version of the wrinkle can then be analyzed to determine the geometry of the wrinkle along with the intensity of the wrinkle. This is another suitable process that can be used in conjunction with the present disclosure.

A method proposed in this disclosure analyzes the ultrasonic data differently to visualize the wrinkle. As will be discussed, the frequency of the ultrasonic signal is used to digitally rebuild multiple layers at once, allowing for the automatic visualization of multiple layers at a time with only a depth marking the start of the digital reconstruction of the part.

### Introduction to Time-Frequency Analysis

The STFT is a commonly used time-frequency transform. The STFT works by moving a sliding window, w(t), where t is time in seconds, over the signal, x(t), to analyze it. At each position of the window, the Fourier transform is found for that time window. The STFT, X(t, f), is defined by Equation 1.1 below.

$$X ( t , f ) = {\int }_{- ∞}^{∞} x ( {t}_{1} ) w ( {t}_{1} - t ) {e}^{- i2π {ft}_{1}} {dt}_{1} \qquad ( 1.1 )$$

Where X(t, f) is the STFT, t is the window location in time, f is frequency, t₁ is the variable of integration in units of time, and j is the complex number i=\sqrt{−1}. In this disclosure, the Hanning window for the window function, w(t). The Hanning window is defined as shown below in Equation 1.2.

$$\begin{matrix}w ( t ) = \frac{1}{2} + \frac{1}{2} cos ( π * \frac{t}{T} ) for \vert t \vert < T \\ = 0 for \vert t \vert > T\end{matrix} \qquad ( 1.2 )$$

In Equation 1.2 above, T is the window length (or time resolution of the transform) in units of time. For the spectral analysis used in this disclosure, the squared magnitude of the STFT is considered as:

$${S}_{x} ( t , f ) = {\vert X ( t , f ) \vert}^{2} \qquad ( 1.3 )$$

The time and frequency resolutions of STFT's are linked. With an increase in the time resolution, the frequency resolution decreases and vice versa. As such, there is a tradeoff between the time resolution and frequency resolution and a balance between the two is needed for each specific application. This tradeoff is known as the uncertainty principle, which states that the product of the time resolution, T, and frequency resolution, B, is lower bounded by

$$B T \geq \frac{1}{4 π} .$$

The CWT is another common time-frequency transform. Similar to the way the STFT moves a window over the signal for analysis, the CWT moves a wavelet, based on a mother wavelet, ψ(t), over the signal, x(t), for analysis. The CWT can be defined as:

$${W}_{s} ( a , b ) = \frac{1}{\sqrt{a}} {\int }_{- ∞}^{∞} x ( t ) ψ ( \frac{t - b}{a} ) d t \qquad ( 1.4 )$$

In Equation (1.4) Wₛ(a, b) is the continuous wavelet transform, t is time, a is the scale factor, and b is the time shift factor. The wavelet is based on a mother wavelet, in this disclosure a Morlet wavelet defined as:

$$ψ ( t ) = {e}^{\frac{{t}^{2}}{2}} cos ( 5 t ) \qquad ( 1.5 )$$

The mother wavelet is modified by the scale, a, and time shift, b, factors to modify its frequency and shift it in time over the signal, x(t). The mother wavelet is passed over the signal multiple times with a different scale factor each time. For each pass, a different time scale factor is used which dilates the wavelet to a different length. This change of time scale can also be thought of as changing the frequency of the wavelet. This results in a two-dimensional representation of time, denoted as b, and scale, denoted as a. The frequency can be approximated, as is done in this disclosure, using the relationship below:

$${F}_{a} = \frac{{F}_{c}}{a} \qquad ( 1.6 )$$

where Fₐ is the approximate frequency Hz and F_{c} is the center frequency of the wavelet in Hz, which in the case of the Morlet wavelet F_{c}≅0.7958 Hz. As the scale factor also changes the bounds of the wavelet the CWT has a dynamic resolution. This means that as the frequency increases, the time resolution increases and the frequency resolution decreases. This can be seen in the CWT.

The WSST was developed by as a tool to improve the sharpness of the wavelet transform, and can be used to apply a reallocation method known as synchrosqueezing to the CWT. Synchrosqueezing is performed on discrete values of the continuous wavelet transform, producing the synchrosqueezed transform, Tₛ(ωₗ, b), through the use of the following equation.

$${T}_{s} ( {ω}_{l} , b ) = {( Δ ω )}^{- 1} {\sum }_{{a}_{k} : \vert ω ( {a}_{k} , b ) - {ω}_{l} \vert \leq Δω / 2} {W}_{s} ( {a}_{k} , b ) {{a}_{k}^{\frac{3}{{2}^{}}} ( Δ a )}_{k} \qquad ( 1.7 )$$

Where Wₛ(aₖ, b) is the continuous wavelet transform from Equation 1.4, aₖ are discrete scale values, with aₖ−aₖ₋₁=(Δa)ₖ, b is the time shift variable, ω(a, b) is the candidate instantaneous frequency defined as

$$ω ( a , b ) = - {i ( {W}_{s} ( a , b ) )}^{- 1} \frac{\partial }{\partial b} {W}_{s} ( a , b ) ,$$

and ωₗ is discrete frequency values, with Δω=ωₗ−ωₗ₋₁. The summation range, aₖ: |ω(aₖ, b)−ωₗ|≤Δω/2, can be described as such: sum over the range of discrete scale values, aₖ, such that the absolute value of the difference between the candidate instantaneous frequency, defined at the discrete scale value, ω(aₖ, b), and the current discrete frequency value, ωₗ, is less than or equal to half the discrete frequency step size, Δω. To clarify, the candidate instantaneous frequency can be thought of as the frequency associated with the time, b, and scale, a. In short, the discrete version of the WSST, shown in Equation 1.7, bins the frequency values, ω, and scale values, a, and reallocates the discrete scale values to the corresponding frequency values. When the frequency and scale variables are treated as continuous, the continuous form of the WSST can be expressed as

$${𝒯}_{s} ( ω , b ) = {\int }_{A ( b )} {W}_{s} ( a , b ) {a}^{- \frac{3}{2}} δ ( ω ( a , b ) - ω ) d a \qquad ( 1.8 )$$

where [symbol] (ω, b) is the continuous form of the WSST, A(b)={a; Wₛ(a, b)≠0} or A(b) is the set formed by the values of a for which Wₛ(a, b)≠0 is true, and δ(ω) is the Dirac delta function.

The WSST can be used for feature/mode extraction as well as signal denoising. All of this is made possible as a result of the sharpening effect of the WSST. A simple example of the sharpening effect of the WSST compared to the CWT can be seen in comparative images.

A more thorough and complete introduction to the WSST includes mathematical limitations and requirements of the WSST and example applications of the WSST. This is another suitable process that can be used in conjunction with the present disclosure.

### Applications of the WSST in Ultrasonic Testing Analysis

The WSST can be used in ultrasonic testing analysis, such as with a ridge detection method for signal decomposition or in other suitable manners, which is slightly different from the method used by MATLAB's wsstridge function used in this disclosure, but the goal of both methods is the same, to determine the dominant frequency of a signal as a function of time. The inverse WSST can be performed on the ridges to produce the corresponding Eigen-modes of the signal, which can be used to compare simulated results to real measurements to prove the validity of their decomposition method. The use of the frequency ridge differs from the use presented in this disclosure as the method presented in this disclosure is used to quantify layer height and visualize missing extrudates in fused filament fabrication manufactured samples.

A thick composite sample with out of plane wrinkles and side-drilled holes can be inspected using a transducer with a center frequency of 5 MHz. The WSST can be used to decompose the raw signal into signals with varying center frequencies, to allow for better differentiation between thick resin layers and side drilled holes. The same center frequency extraction method can be used to determine the frequency dependence of reflections from different defects including side-drilled holes (in the experimental scans), delaminations (in the simulated scans), and resin rich regions. This is another suitable process that can be used in conjunction with the present disclosure.

The WSST can be used for producing the dispersion curves of laser-excited surface acoustic waves. The dispersion curves can then be used to estimate the elastic constants of the inspected material. The WSST can be use to denoise a signal from an electromagnetic acoustic transducer used for detecting cracks in a rail foot. The WSST, singular spectrum analysis (SSA), and ensemble principal component analysis (PCA) on simulated Lamb Waves produced in a simulated CFRP laminate with intentional damage can be used to emulate typical inter-laminar damage. The main function of the WSST is to extract damage features in the signal. The performance of various time-frequency transforms for attenuation estimation in waves can be analyzed. BP performed the best while the WSST was found to have the second best performance and Complete Ensemble Empirical Mode Decomposition CEEMD was third. The WSST can be used to extract the main modes present in signals measured with a laser-vibrometer. The WSST based extraction method can improve the detectability of a void in a cementitious material. This is another suitable process that can be used in conjunction with the present disclosure.

All analysis methods presented in this section presents examples of the WSST being used for ultrasonic signal analysis. The WSST was used to great effect to perform analysis in the time-frequency domain, but these are suitable processes that can be used in conjunction with the present disclosure.

### Essentium Manufacturing

Additively manufactured (AM) samples can be manufactured on an Essentium HSE 180 S HT, but other suitable systems can also or alternatively be used. The 0.8 mm Hozzle, or “hot nozzle”, Essentium's proprietary nozzle design, can be used for all AM sample manufacturing. The material used for all additively manufactured samples is Essentium PCTG. The speed of sound can be measured using a pulse echo ultrasonic signal from a block of PCTG printed from the Essentium printer. The thickness of the sample can be measured with a caliper at multiple locations to find an average thickness. The sample can be placed in an immersion tank and a nominal 5 MHz focused immersion transducer can be used to collect a pulse echo a-scan of the sample. From the pulse echo a-scan, the peak of the front wall and the peak of the back wall can both marked. The time difference between these two points in the a-scan can then be plugged into Equation 2.1 below.

$$\begin{matrix}a . & \\ c = \frac{2 d}{Δ t} & ( 2.1 )\end{matrix}$$

Where c is the speed of sound, At is the time difference between the front and back wall, and d is the measured thickness of the sample. An immersion ultrasonic testing apparatus can be used. The density of PCTG is provided by Essentium and is used for porosity calculations. Table 2.1 shows the properties from the material specification sheet that are used in the present study.

All additively manufactured samples produced can have the same exterior dimensions, such as 3 in ×3 in ×0.25 in (76.2 mm×76.2 mm×6.35 mm) or other suitable dimensions. A difference between samples are the print parameters used for each sample, such as the extrusion multiplier and layer height. The 0.25″ dimension can be the through thickness dimension with one of the two 3″×3″ sides placed flat on the build table.

TABLE 2.1
Material Properties of Essentium PCTG

| Property | Value |
|---|---|
| Specific Gravity, g/cm³ [53] | 1.23 |
| Speed of Sound, m/s | 2220.53 ± 43.64 |

### Simplify 3D

The g-code for the Essentium printer can be produced using the Simplify 3D slicing software. Simplify 3D is an industry grade software used for a variety of 3D printers. The Simplify 3D environment is customizable to fit the printer that the part will be manufactured on. Essentium, Inc. provided the profile for their HSE 180 HT printer that matches the printer used. Simplify 3D has a large variety of settings allowing for a lot of customization in the process parameters.

An exemplary process for producing the g-code to control the Essentium printer is broken into several steps. In the first step the part is designed in a computer aided design (CAD) software, in this disclosure this is performed using SOLIDWORKS. The CAD file is then converted into an STL file which saves the surface geometry of the part. The STL file is imported into Simplify 3D, and within Simplify 3D the part is positioned and oriented on the virtual build plate of the printer. The print parameters are then determined and set within Simplify 3D. The two parameters for which this disclosure investigates their sensitivity to acoustic waves are the extrusion multiplier (i.e., porosity) and the layer height. The extrusion multiplier is of interest as there is a correlation between the inter-bead bead void concentration (i.e., porosity) and the extrusion multiplier. The layer height is of interest as there is a link between the layer height and ultimate tensile strength, Young's modulus, flexural strength, toughness, resonant frequency, dimensional accuracy, surface roughness, and print times. After the print parameters are set and the geometry is placed in the desired location and orientation on the build plate, the Simplify 3D software slices the geometry, creates a layer-by-layer print path and extrusion rate, and produces the g-code for the Essentium printer.

In Simplify 3D there is also the ability to change print parameters at designated heights. For example, from 0 mm, the build plate, to 2.5 mm, the print parameters could be set a certain way and then the user could designate that the print parameters change at the 2.5 mm mark for the rest of the print. Any print parameters that can be modified in the Simplify 3D software can be changed during the print in this way (e.g. layer height, extruder temperature, extrusion multiplier, etc. can be changed mid-print). This functionality is used to produce samples for some of the applications discussed in this disclosure (e.g., layer height samples with multiple layer heights in one sample).

The default print parameters that were used for all AM samples are shown in Table 2.2. Many parameters used are recommended by Essentium. For each type of sample in which it is required (i.e., porosity and layer height samples), one print parameter is changed while keeping all else the same.

Example print parameters in Table 2.2 that differ from the defaults set by Essentium are provided as follows. The Extrusion Multiplier modifies the extrusion speed of the printer by the factor set as the extrusion multiplier. For example, if the extrusion multiplier is set to 0.8 and the normal extrusion speed is set to 10 mm/s, the modified extrusion speed would just be the normal extrusion speed multiplied by the extrusion multiplier, which in this case would result in a modified extrusion speed of 8 mm/s. The true default extrusion speed is set by Essentium and is unknown.

TABLE 2.2
Example default print parameters of note for AM samples

| Print Parameter | Value |
|---|---|
| Extrusion Multiplier | 0.95-0.99 (1.00*) |
| Primary Layer Height (mm) | 0.20-0.40 (0.35*) |
| Nozzle Diameter (mm) | 0.8 |
| Extrusion Width (mm) | 0.8* |
| Top Solid Layers | 0 |
| Bottom Solid Layers | 0 |
| Outline/Perimeter Shells | 3* |
| Outline Direction | Inside-Out* |
| First Layer Height | 100%* |
| First Layer Width | 100%* |
| First Layer Speed | 80%* |
| Use Skirt/Brim | Yes* |
| Skirt Layers | 1* |
| Skirt Offset from Part (mm) | 1.00* |
| Skirt Outlines | 5* |
| Interior Fill Percentage | 100% |
| Interior Fill Pattern | Rectilinear |
| Outline Overlap | 18%* |
| Infill Extrusion Width | 100%* |
| Internal Infill Angle Offsets (deg) | [45-45]* |
| Primary Extruder Temperature (° C.) | 340* |
| Heated Bed Temperature (° C.) | 80* |
| First Layer Fan Speed | 0%* |
| Default Fan Speed | 30%* |
| Default Printing Speed (mm/min) | 6000.0* |
| Production Mode | Small* |

*indicates Essentium recommended setting

The top solid layers and bottom solid layers defines the number of layers on the top and bottom of the part respectively that should be fully filled in rather than printed with the set Interior Fill settings, and they only affect a print when Interior Fill Percentage is below 100%. However, to prevent any unknown differences between a “Solid Layer” and an “100% Infill Layer” affecting the ultrasonic inspections, both Top Solid Layers and Bottom Solid Layers can be set to 0. Interior Fill Percentage is the percentage of the inside of the part that is filled with material. The Interior Fill Percentage can be set to 100% if the focus is to inspect fully filled 3D printed samples and measure or visualize features within said samples. The Interior Fill Pattern is inconsequential as when Interior Fill Pattern is set to 100%, Interior Fill Pattern does not control anything about the print.

### Fused Filament Fabrication Manufactured Samples

Three different types of additively manufactured samples can be prepared in accordance with this disclosure, but other suitable samples could also or alternatively be used. Samples with varying porosity, differing layer heights, and missing extrudates are described.

### Varying Porosity

Samples with varying porosity can be produced by modifying the extrusion multiplier in the print settings in Simplify 3D which simulates varying degrees of inter-bead porosity in the samples. The extrusion multipliers that can be used in this example vary from 0.95-0.99 with increments of 0.01. Any extrusion multiplier higher than 1.00 over fills the print area and causes print failure. An extrusion multiplier of 1.00, which is the manufacturer's recommended value, can also be hit or miss with prints when the interior fill percentage is set to 100%. The lowest extrusion multiplier of 0.95 can be chosen so that a wide range of extrusion multipliers can be be tested (i.e., five different extrusion multipliers offered an adequate range of porosity levels).

### Differing Layer Heights

Samples with differing layer heights can be created by changing the layer height setting in Simplify 3D on a layer-by-layer basis. Samples can be produced with layer heights varying from 0.2 mm to 0.4 mm with increments of 0.05 mm. There can also be layer height samples with multiple layer heights (e.g., the first 2 mm of the part would have a layer height of 0.2 mm and the rest of the part would have a layer height of 0.25 mm). The layer height sample naming convention can use the prefix LH in the name to indicate Layer Height, followed by the layer height dimension in millimeters, and then a specific part identifier. For example, the part LH_0.25_002 can be a layer height sample with a 0.25 mm layer height and can be the second sample to be studied. For samples with two layer heights “var” can be added to the name. For example, the part LH_var_0.25_0.2 can be a two layer height sample with the layer heights 0.25 mm and 0.2 mm present.

### Missing Extrudates

To produce samples with missing extrudate, g-code for the standard AM sample can be created using Simplify 3D. The g-code can be opened in a text editor and can be manually modified so that the extruder does not deposit material for one of the beads within the layer. The specific bead not deposited can be placed near the center of the part (i.e. the longest diagonal of the selected layer would not be extruded). Within the g-code, lines responsible for printing a line of material can be designated as follows: G1 X− Y− Z− E−. G1 indicates that this move will occur at the set feed rate. X− indicates the distance that will be traveled in the negative x₁-direction. Y− indicates the distance that will be traveled in the positive x₂-direction. Z− indicates the distance that will be traveled in the positive x₃-direction. E− indicates how much the extruder will extrude during this move. The hyphens indicate where values would be input. In g-code for the Essentium system all distances are input in mm. For example, G1 X1.200 Y−2.300 Z0 E1.300 would indicate a relative move of 1.2 mm in the negative x₁-direction, 2.3 mm in the negative x₂-direction, and 0 mm in the x₃-direction and during the move, the extruder would move 1.3 mm. The extruder would extrude more than 1.3 mm of material, however, because the diameter of the filament can be greater than the diameter of the extruded material. The diameter CAN decrease, but the volume can be conserved so a longer amount of material can exit the nozzle than what the extruder would push through. It is valuable to note, that the extruder movement does not directly correspond to the length of the material extruded as the diameter of the material pushed into the Hozzle, Essentium's proprietary nozzle, by the extruder is greater than the diameter of the material exiting and being deposited from the Hozzle.

In order to modify the selected line of g-code, the g-code file is opened in Notepad and modified directly. The chosen line of g-code is simply modified by setting the extruder move to 0. This tells the printer to not extrude at all during that move. What this results in is a missing bead as intended, but an unintended side effect is also present in this method. The next deposited bead tends to not have material extruding again until partway into the move. This is a result of lag associated with stopping the extruder completely and starting it up again. When results are presented, this inspection will focus on visualizing a single missing bead, but a future study could be performed to identify how many missing parallel paths are missing and where these defects occur.

Manufacturing of CFRP Laminates with Wrinkles

Only one CFRP laminate sample was considered for this disclosure, but others could also or alternatively be used. The procedure outlined in this section can be used to produce the sample with two wrinkles using a wet layup method and a hot press. The sample can be produced using a plain weave carbon fiber fabric. The manufacturing method is as follows.

An aluminum plate, or tooling, is coated with a thin layer of wax that acts as a release agent. A border around the plate, 1″ from each end, is cleaned of wax and vacuum gum tape is applied. The gum tape keeps the resin from spilling out during both the layup process and the curing process. The lay-up was composed of all 0° layers with 28 total layers (i.e., [0]₂₈). Resin is mixed with hardener using a FlackTech vacuum mixer. The mixer starts with spinning the resin at 800 RPM for 30 seconds and then increases speed to 1500 RPM for 4 minutes and 30 seconds. During the higher RPM portion of the mixing procedure, vacuum is pulled. This process uniformly mixes the resin and hardener and minimizes the amount of air in the mixture. The mixed resin is then immediately used for the wet layup process before the resin hardens past the point of usability. The mixed resin has a 30-minute working time.

To start the layup process, the area of the aluminum plate to contain the sample, which is centered on the plate is coated with resin using a clean paintbrush. Then a layer of carbon fiber was placed on the resin and thoroughly wetted (i.e., saturated with resin), if more resin is needed to wet the layer, then more is applied using the same paintbrush. Every subsequent layer is laid on the previous one and thoroughly wetted. During the layup process, two tows of unidirectional carbon fiber were inserted between layers 13 and 14 to produce two wrinkles in the sample. As with the rest of the layup, the unidirectional tows were thoroughly wetted before moving on with the next layer. These cross tows were placed parallel to each other in order to only produce simple wrinkles where they were located. The cross tows were separated sufficiently such that the wrinkle geometry of one wrinkle does not affect the geometry of any other wrinkles in the sample.

A second aluminum plate is then also coated with a thin layer of wax. The plate is then placed on top of the layup, wax side down, centered over the other plate to produce a kind of sandwhich. The sample is left at room temperature for 6 hours since the resin was mixed to allow for the gelation period of the resin to pass. The sample is then transferred to the Carver Auto Series Plus hot press. Once placed in the hot press, the rest of the curing cycle commences. First, pressure is ramped over the course of 2 hours to 40 psi while the temperature is held constant at 75° F. (room temperature). Next, the temperature is ramped over the course of one hour to 180° F. while pressure remains constant. Then the temperature and pressure is help constant for 8 hours to allow for curing. Once the resin has fully cured, the hot press is cooled back down to 75° F. over the course of one minute while pressure is held constant. The hot press has active cooling that allows for this rapid cooling rate. Finally, the pressure is released and the cure cycle is completed. The part is then removed from the aluminum tooling the composite was cured in and is ready for post-cure machining needed to prepare it for inspection. For the sample used in this study, all rough edges are removed using a wet band saw. To create a sample with final dimensions of 127 mm×177.8 mm×6.23 mm.

### Immersion Scanning System

Immersion UT scans can be performed using a 3-axis system using Velmex Bi-Slide motorized linear motion slides with a custom-built frame or other suitable systems. The motors are connected to Velmex VMX motor controllers. Motion of the system during scans is controlled by commands sent to the motor controllers using custom MATLAB scripts. Small parts of the scripts were developed and modified for this disclosure, but the overall functionality remained the same.

Scans are performed in a raster pattern for a c-scan, and in one singular scan pass for a b-scan. During scans, the transducer moves along the x₁ direction to cover the width of the scan area and then the transducer moves in the x₂ direction to index the raster pattern. The x₁ direction is often termed the Scan-direction while the x₂ direction is often termed the Index-direction. B-scans were collected for layer height samples, and c-scans were collected for the porosity, missing extrudate, and CFRP wrinkle samples.

The pulsar-receiver can be an Olympus Focus PX system with the Focus PC software on a connected computer managing the firing of the transducer and the data collection, or other suitable systems. Settings related to UT data collection can be set in the Focus PC software prior to a scan. For scans of porosity and layer height samples, flat faced Olympus immersion transducers were used. For scans of missing extrudate and CFRP wrinkle samples, spherically focused Olympus immersion transducers or other suitable transducers can be used.

### Density Measurements

For the porosity samples, density measurements can be gathered using ASTM D792-20. A mass balance apparatus can be used for the density measurements, such as with a hanging basket made of solid copper wire and a tub below a scale filled with water for the measurements. The measurement apparatus can be a Mettler Toledo AG104 scale that is calibrated with the procedure listed in ASTM D792-20 or other suitable apparatuses. The copper wire basket and tub of water can be placed underneath the scale. The tub of water can be filled such that the completely submerged.

The sample can be weighed on the scale to measure its mass in air. Then the sample is removed from the scale and the wire basket is hung from the bottom of the scale and is partially submerged in the water at the same depth as will be used when the sample will be placed within the basket. The mass of the wire basket in the water is then recorded and the temperature of the water is recorded. After the mass of the basket is measured, the sample is placed in the wire basket and is fully submerged in the water. The mass of the whole system, the sample fully submerged and the wire basket partially submerged, is then recorded. All of these measurements are used in Equation 2.2 below:

$$\begin{matrix}a . & \\ {ρ}_{sample} = {ρ}_{water} ( {T}_{water} ) \frac{a}{a + w - b} & ( 2.2 )\end{matrix}$$

where ρₛₐₘₚₗₑ is the density of the sample, T_{water} is the temperature of the water, ρ_{water} is the density of the water as a function of T_{water}, a is the apparent mass of the sample in air, w is the apparent mass of the partially submerged wire basket, and b is the apparent mass of the sample fully submerged and the wire basket partially submerged in water. The value for the density of the water as a function of temperature, ρ_{water} (T_{water}), is provided in ASTM D792-20. Each sample can be measured 5 times and the results can be averaged.

The change in porosity of the porosity samples, those manufactured with varying extrusion multipliers, can be determined using Equation 2.3 below.

$$p = ( 1 - ( \frac{\frac{{W}_{s}}{{V}_{s}}}{{ρ}_{PCTG}} ) ) * 100 \qquad ( 2.3 )$$

where p is the porosity as a percentage, Wₛ is the weight of the samples, Vₛ is the volume of the sample, and ρ_{PCTG} is the density of PCTG as provided by Essentium. As the weight devided by the volume is the same as density, Equation 2.3 can be rewritten as shown below in Equation 2.4.

$$\begin{matrix}a . b . & \\ p = ( 1 - ( \frac{{ρ}_{s a m p l e}}{{ρ}_{PCTG}} ) ) * 100 & ( 2.4 )\end{matrix}$$

In Equation 2.4, ρₛₐₘₚₗₑ is the density of the sample as calculated according to ASTM D792-20. The change in porosity calculated by Equation 2.4 is used as the porosity for the purpose of calculating results. The calculated values are considered the change in porosity as the original PCTG could have unknown posority present already, so a description of what is being calculated using Equation 2.4 is the change in porosity.

Layer Height Measurements with CT

With the goal of comparing with the layer height measurement method developed in this disclosure, a computed tomography (CT) scan can be performed on a two-layer height sample. Using that scan, the layer height of the sample can be measured. To perform the measurements, a cross-sectional image of the sample was viewed in efX-View and the measurements were made with tools built into efX-View.

For a portion of the cross-sectional image from the sample from the CT scan small voids in the sample can be are used as landmarks when measuring the layer height of the sample as they occur on the interface between the layers. Based on observations of the captured CT images, it may be observed that the left edges of the voids are flat while the right sides of the voids are not, such as when the voids form on the bottom of the layers so the top of the previous layer forms the flat bottom of the void.

To measure the layer height, the measurement can start from the bottom surface, and the distance from where the part can start to the left edge of the first void is measured. In order to produce the most accurate measurements possible with the images available, measurements can be made from the left edge of the first voxel of the bottom surface to the left edge of the first voxel of the void. The next layer is measured from where the first measurement ended, using the voxels to make sure that the next measurement starts where the previous one left off. The measurement for the second layer can be performed from the left edge of the first voxel of the first void to the left edge of the first voxel in the next void. This process can be repeated for every layer in the sample. The layer height measurements are compared to the measurements taken using the method developed for this disclosure.

### Ultrasonic Scanning and Analysis

### Scanning of Additive Manufactured Samples

In this disclosure there are three different types of additively manufactured (AM) samples considered; varying porosity, varying layer height, and samples with missing extrudate. Other suitable samples can also or alternatively be used. Each of the types of samples can have a different scan method. For all scans performed on AM samples, signal averaging can be applied during the scan by averaging 4 a-scans for every a-scan collected.

For porosity samples, c-scan scans can be performed using a flat faced 5 MHz Olympus transducer or other suitable devices. A c-scan scan can follow a raster scan path. All the scans for porosity samples can be performed over a 40 mm×40 mm area with a resolution of 0.2 mm in both the x₁ and x₂ directions. The dominant frequency of samples with a layer height of 0.35 mm can be approximately 3.34 MHz. From the transducers available for this disclosure, a 5 MHz transducer is closest to the ideal frequency value without being under it. A flat faced transducer can be used for the porosity samples if the goal is to detect inter-bead porosity, which describes void content in a projected volume, and the signal of a flat faced transducer can be affected by the volume under the transducer. In order to get a measure of the porosity for the part as a whole, a large volume of the part can be scanned within one signal, and a c-scan makes that possible. From the c-scan, the a-scans can be first shifted so that the front wall response of each signal is aligned in time to account for any minor curvature or unevenness in the surface of the part. Once each of the individual a-scans are aligned in time, an average a-scan can be produced by averaging the value of each a-scan at each point in time. This average a-scan can be analyzed for any porosity samples in order to prevent any localized indications in the component from affecting the measure of porosity, which is measured over the whole volume.

For layer height samples, b-scan scans can be performed using two different flat faced Olympus transducers with a nominal frequency of either 5 or 7.5 MHz. A b-scan scan can be performed by scanning one singular line in the x₁ direction. The scan can be performed in one 40 mm line with a resolution of 0.2 mm. The frequency of the transducer can be selected based on the ideal frequency for the layer height(s) present in the sample. A flat faced transducer can be used so that the geometry of each layer has a minimal effect on the measurements of the layer height.

For any missing extrudate samples, c-scan scans can be performed using a focused Olympus transducer with a nominal frequency of 5 MHz or other suitable equipment. All the scans for missing extrudate samples can be performed over a 40 mm×40 mm area with a resolution of 0.2 mm in both the x₁ and x₂ directions. A 5 MHZ transducer can be used as the dominant frequency of samples with a layer height of 0.35 mm. All missing extrudate samples are approximately 3.34 MHz which is close to 5 MHZ. A focused transducer can be used for the purpose of producing scans with high resolution allowing for detailed geometry to be scanned and visualized. The scans can identify the presence of the missing extrudate in the sample and visualize the missing extrudate; a focused transducer allows for high enough resolution scans, in terms of the spatial coordinates x₁ and x₂, to achieve that goal as the width of the beam of the transducer is the narrowest inside the part allowing for small features, such as a missing extrudate, to be identified. A time corrected gain was applied to all of the samples in order to make sure the back wall was clearly present in all scans of the samples.

### Scanning of Carbon Fiber Reinforced Polymer Composites

Scans of CFRP composite laminates can be performed using spherically focused Olympus transducers with nominal frequencies of 7.5 MHz or 10 MHz or other suitable devices. Scans can have a resolution of 0.2 mm in both the x₁ and x₂ directions with scan sizes of 120 mm in the x₁ direction and 10 mm in the x₂ direction or other suitable resolutions.

### General Ultrasonic Analysis

For all sample types presented in this disclosure, there are some preprocessing steps that can be performed prior to the steps described in the following sections. The a-scans can be trimmed to include the portion of the signal that is needed for analysis and aligned in time, by shifting each a-scan so that the first peak in the signal above a designated threshold is at the same point in time. This shifting is performed according to a surface fit to the first peaks of all of the a-scans in order to prevent any outliers in the first peaks from affecting the resulting aligned data set. Next, smoothing is performed to reduce the effect of inconsistencies in the ultrasonic waves from a-scan to a-scan. After all of these preprocessing techniques are performed, all of the a-scans are normalized on a scale from −1 to 1.

Smoothing can be performed using a MATLAB function, smooth2a, which uses a mean filter over a rectangle of size selected by the user to smooth a 2D matrix, or other suitable processes. For example, in all cases for wrinkle characterization, the rectangle is 9 points by 9 points with the data point to be changed in the middle of the rectangle. Similar to the movmean function, for rectangles near the end of the 2D matrix, only the data present within the rectangle is used, so if there is any missing data within the rectangle, that point is ignored. In all cases for this disclosure, the 2D matrix input is a timestep in the full 3D matrix of data. The whole 3D matrix is smoothed by smoothing at each timestep in the data.

For cases where depth in time is converted to accurate depth measurements for analysis purposes, Equation 3.1 below is used for that purpose.

$$d = \frac{c t}{2} \qquad ( 3.1 )$$

In Equation 3.1, c is the speed of sound of the material, t is time the signal takes to pass through the material, and d is the thickness of the material for which the acoustic signal enters and reflects back to the transmitting transducer. Observe there is a 2 in the denominator Equation 3.1 because the ultrasonic signal is captured in pulse echo mode.

In most cases, the time scale, or depth scale, is zeroed on the first peak in the average a-scan that passes a set detection threshold. This time shift is applied to the normalized a-scans. The detection threshold is typically set to 0.1. The first peak that occurs in the average a-scan that is above 0.1 is set as the zero in the time or depth scale.

### Porosity Analysis in Additive Manufacturing

With the goal of characterizing porosity in FFF additively manufactured components, a method that considers the frequency of the ultrasonic signal was investigated. Not using the back wall signal for the ultrasonic scan allows the frequency of the ultrasonic signal to characterize porosity. As more porosity is present, higher frequencies will attenuate at an increased rate compared to lower frequencies. Analyzing the ultrasonic signals from FFF porosity components (i.e., components with extrusion multipliers lower than 1) in the time-frequency domain can allow for the analysis of attenuation of a large range of frequencies through the whole length of an a-scan.

### Short-Time Fourier Transform Based Analysis

The first method attempted to achieve this goal involved the use of the STFT. The math behind the STFT can be seen in Equation 1.1 and Equation 1.2. The MATLAB function stft or other suitable processes can be used to perform the short-time Fourier transform. The STFT allows for analysis of a signal in the time-frequency domain. It can be useful for understanding how the frequency content of a signal changes with respect to time. Example settings used for performing the STFT can include: the Frequency Range can be set to be one sided, the length of the FFT (i.e., the number of points in the frequency domain) can be set to 2048, and the window can be a periodic Hann window with a length of 32 samples. As the Olympus Focus PX system has a sampling frequency of 100 MHz, thus from the Nyquist Theorem the maximum frequency that can be measured in any frequency analysis method is 50 MHZ.

As discussed, the STFT breaks the signal down into multiple sections each with the same window size. The window size determines the resolution in the time and frequency domains. When increasing the window size, the time resolution is decreased while the frequency resolution is increased while the opposite is true when decreasing the window size. As a result, a balance of time and frequency resolutions can be found. For the example signals analyzed in this disclosure, a window size of 32 samples can work well. However, as the effect of window size on the results in this method is not the focus of this disclosure, a more optimized window size can be selected where suitable.

The first result presented using the STFT involves tracking when each frequency drops below a certain magnitude in the STFT. In order to perform this analysis, first the STFT is normalized with the highest magnitude set to 0 dB. Next, a magnitude threshold value is chosen. The threshold value varies from scan to scan. The goal of the analysis is to see how the different frequency components of the signal attenuate. In order to do this, the frequencies at which the magnitude component drops below the threshold is found. Then the occurrence at each time that is associated with the highest frequency is kept and all other points are thrown out. This means that there is only one frequency tied to each time step in the STFT.

The threshold is picked such that the resulting curve from the previous two steps is exponential in shape. If the threshold is too high, then the window-to-window changes in amplitude of the signal affect the shape of the curve drastically. If the threshold is too low, then the first few windows will all be set at 50 MHz which also affects the shape of the curve. When both of these problems are avoided, the resulting curve is exponential in shape.

At this point, the curve is gated so only the portion of the curve with a proper exponential shape is included and anything past the back wall reflection is ignored. Once the curve is gated, a linearized regression, fitting the curve to an equation of the form F=Ae^{-Bt}, is performed, where F is in Hz, t is in s, and B is in s⁻¹. The resulting exponential coefficient, B, is indicative of the rate at which the frequencies decay with time. A high exponential coefficient would indicate that higher frequencies are dying out faster while lower frequencies are less affected but attenuating at a faster rate as well. A low exponential coefficient would indicate that higher frequencies are attenuating slower while lower frequencies are still less affected but attenuating at a slower rate as well. The curve being exponential makes sense as the higher frequencies will die out, and thus pass the threshold, before the lower frequencies. The exponential coefficient is then used to compare samples. The results from this method will be compared for multiple samples.

There is a limitation with the STFT due to its the limited resolution that made it difficult to distinguish frequencies below 5 MHz while still having an adequate time resolution. Porosity samples can be scanned with a nominal 5 MHz transducer.

In order to address the resolution limitation, other time-frequency transforms were explored in order to determine their efficacy in characterizing porosity in extrusion multiplier samples. The next time-frequency transform considered was the CWT.

### Continuous Wavelet Transform

The CWT offers a potential improvement on the time-frequency analysis of ultrasonic signals over the STFT due to the advantages it offers as a result of its varying time-frequency resolution. As such, the potential it could offer is briefly investigated in this disclosure. The math behind the CWT is presented in Equation (1.4). Due to the issues with the cone of influence as discussed, there must be a short time buffer before the data of importance can be present. As such an average a-scan with a time buffer at the front that contains no data can be used for the wavelet analysis explanation. The CWT does a much better job at distinguishing frequencies below 5 MHz compared to the STFT, allowing for more detailed analysis in the frequency range of the transducer.

While the CWT addresses the issue of low frequency resolution, there is no indication that higher frequencies are attenuating differently than lower frequencies. While it seems that frequencies above 6 MHz attenuate faster than frequencies below that, their initial magnitude is also lower. As such it would be difficult to properly determine how the attenuation changes with frequency. The width of frequency indications made it difficult to identify not only the dominant frequency, but it was also not possible to see small changes in the frequency. This led to a search for a time-frequency transform with sharper time-frequency plots.

### Wavelet Synchrosqueezed Transform

WSST greatly increased the ability to identify small changes in the frequency content of the signal as a function of time. With the more precise information from the WSST, it was noted that with narrow band transducers, there was not an appreciable change in the frequency content as a function of time that could be used for identification and characterization of porosity. The average a-scans from the porosity samples do not show an appreciable difference in the time-frequency domain that could be used to reliably distinguish the samples.

There is an increased sharpness in the time-frequency domain from the WSST. All of the samples have nearly the same dominant frequency after the front wall portion of the signal. The shape of the data is a function of the selected transducer, but after a front wall the frequency changed as was dominated by variations within the part. The dominant frequency after the front wall is associated with the layer height of these samples, which was set to 0.35 mm.

The front wall has two frequency peaks, one being stronger than the other. This type of indication appears on every scan and the specific frequencies present are dependent on the transducer used for the scan, not on the sample itself. As the focus of this disclosure is not on the time-frequency analysis of transducers, this part of the signal will not be further addressed.

### WSST-Based Layer Height Analysis

WSST allows for the layer height to be determined based on the dominant frequency. As such, a method using the WSST to measure the layer height of an AM sample was determined. Before getting into the detail of layer height analysis, first the dominant frequency as a function of time needs to be picked out of the WSST data.

In order to extract the frequency information needed for further analysis, first an a-scan is collected from the sample. A method for quantifying layer height using frequency is presented in this disclosure and will be shown to be an accurate and automated method for determining layer height. The WSST of the a-scan is produced using MATLAB's wsst function or other suitable functions. In order to select the dominant frequency as a function of time, the MATLAB function wsstridge or other suitable functions are used to determine the ridge in the WSST data.

The wsstridge function determines the dominant frequency as a function of time. As part of the input for the function, a penalty value can be set. Without the penalty value, the function returns the frequency with the highest magnitude at each point in time. However, this means the frequency value jumps around a great amount, mainly in the front wall portion of the signal. To decrease the jumping and follow the dominant frequency without constant jumps, a penalty value can be set. The penalty value decreases the apparent value of the magnitude of the frequencies in the next time step based on the distance from the current frequency in the ridge. This reduces the jumping drastically.

The ridge function may return more than one ridge. For each ridge following the first, all points where the previous ridges were present are ignored for the formation of the next ridge. It can also be thought of as the second ridge to be following the second most dominant frequency and the third ridge to be following the third most dominant frequency and so on. In this disclosure, only the first and second ridges are considered.

The second ridge drops in frequency near the 5 μs mark. This is a result of either the signal attenuating to the point that the frequency associated with the layer height is no longer prevalent enough to be properly tracked, even with a third ridge, or the back wall is reached. The back wall signal has a lower frequency than internal reflections have. Similar to the front wall of the signal, the back wall of the signal is not considered in this work as it is not indicative to the layer height in the sample.

Using the second ridge, the jump present can be accounted for to case in analysis. The first ridge can suddenly drop in frequency to where the frequency value of the second ridge was prior to the jump, and the second ridge increases in frequency to where the frequency value of first ridge was prior to the jump. This jump can be removed by considering the gradient of both ridges. Any point at which either of the gradients has an absolute value above a threshold, which is chosen for the specific scenario, is marked along with its sign (i.e., negative or positive). Then the marked points for both gradients are compared and at the times that both gradients have marked points with opposite signs, those points are marked separately. This process can be shown using a red line which points in the gradient of the first ridge are marked with their sign, a green line shows which points in the gradient of the second ridge are marked with their sign, and a blue line shows which points at which both gradients have marked points and opposite signs. The threshold for the gradients is adjusted so that only the big jump in the ridges is. Once this jump is properly identified, the portion of the ridges after the jump are switched. This is done with the following procedure. To find where the flip starts, the script starts from the first marked jump point and works backwards on the gradient of each ridge, looking for the first point in both gradients that is zero. Those points mark the start of the region of each ridge to be modified. The frequency value of those points for each ridge is kept. To find where the flip ends, the script starts from the last marked jump point and works forwards on the gradient of each ridge, looking for the first point in both gradients that is zero. Those points mark the end of the region of each ridge to be modified. The frequency value of those points for each ridge is kept. To rebuild the first ridge with the flip the following process is perform. The region to be modified starts with the first point on the first ridge and the second point on the second ridge. The region is then filled in; the first half of the region is filled with the frequency from the first point of the first ridge region and the second half is filled with the frequency from the second point of the second ridge region. The process is repeated for the second ridge with the opposite points. This process makes sure that the frequency associated with layer height is more properly followed. While increasing the penalty value would remove the jump as well, when it is raised enough to remove it, often the appropriate ridge is not tracked properly, and a lower frequency is tracked. As a result, the method explained above was used to track the first and the second dominant frequency peaks.

For all analysis methods further explained, the higher frequency ridge can be used for the analysis of the layer height, missing extrudate, and carbon fiber laminate wrinkle visualization samples.

### Layer Height Analysis in Additive Manufacturing

Performing layer height analysis for the additive manufactured component uses the first ridge from the WSST.

For the purposes of determining the efficacy of this method, two types of layer height samples were analyzed. The first type of sample has just one layer height for the whole of the print. The second type of sample has two-layer heights and the layer height value changes after 2 mm of printing. There are also two-layer height analysis methods that are presented. The first determines the layer height(s) present in the part already knowing how many layer heights were set. The second determines the layer height as a function of depth into the part. Both methods use Equation 3.2 which relates layer height to frequency.

$$\begin{matrix}a . & \\ LH = \frac{c}{{2}^{n} f} & ( 3.2 )\end{matrix}$$

In Equation 3.2 LH is the layer height, c is the speed of sound, f is the frequency obtained from the first tracked ridge in the WSST analysis, and n is the harmonic factor which is used to deal with “layer height harmonics.” The harmonic factor, n, is always an integer (n∈ [symbol] ).

### Single Layer Height Samples

To determine the layer height in a sample with a singular layer height, the largest region of the first ridge that has a gradient of the moving mean within chosen bounds is used. A moving mean of the ridge can be produced from the ridge in order to smooth out the gradient of the ridge. For all layer height samples, the moving mean can be performed using the previous 35 points and the following 20 points (i.e., 0.35 us before the point and 0.2 μs after the point). The moving mean of the ridge can be overlaid on the same WSST. If a point does not have the full designated region from which the mean can be made, the points present in the window can be used for the calculated mean value. For the samples presented herein, the bounds for the moving mean gradient are set to

$$\pm 1 * 1 {0}^{- 4} \frac{H z}{μ s} .$$

The largest region of the moving mean gradient that is within those bounds is used for layer height calculations. A large jump in the data can occur as a result of attenuation of the signal passing an analyzable value. The smoothing that the moving mean provides can prevent sudden jumps in the ridge due to noise in the data from reducing the analysis region's size from what it should be. The region size can change by not using the moving mean for determining the size of the analysis region. The gradient of the ridge itself can be used for determining the analysis region, and the wrong region is selected as a result. The gradient of the moving mean of the frequency ridge can be used for selecting the analysis region so the desired region can be selected.

The largest region of the moving mean gradient that fits within the set bounds can be used for analysis. A region of the ridge as marked on top of the WSST, not the moving mean of the ridge but the ridge itself, can be averaged to find the frequency associated with the layer height. That gives one frequency value for the whole part which can then be plugged into Equation 3.2 with n=1 resulting in a layer height of LH=0.1937 mm. The resulting layer height of LH=0.1937 mm is close to the value set when printing the sample of 0.2 mm for this one example.

### Double Layer Height Samples

Additional samples can be generated with two different layer heights, termed a double layer height sample. The method for determining both of the layer heights set in a double layer height sample is performed similarly to the method for single layer height samples. The same analysis is performed on the moving mean of the ridge. However, instead of picking the largest region of the gradient that lies within the set bounds, the two largest regions within the set bounds are marked for analysis.

An average a-scan from a double layer height sample scan can have a 0.25 mm layer height for the first 2 mm and a 0.20 mm layer height for the remainder of the sample. The WSST associated with this a-scan can change around 2.4 μs, after which the frequency peak can shift from ˜4.5 MHz to ˜6 MHz.

The first frequency ridge can be overlayed on top of the WSST, to make it easier to see the mark where the frequency shifts to a higher frequency, which indicates a second layer height being present in the sample. The procedure for determining both of the layer heights present is similar to the procedure used with a single layer height sample. When determining the regions associated with the two layer heights, the two largest regions of the moving mean gradient that fit within the selected bounds can be marked and used for picking out the two frequencies associated with the two layer heights. Just like with the singular layer height samples, the two regions determined from the moving mean gradient can then be picked out of the ridge and averaged to determine the frequencies associated with each section. Both frequencies can then be plugged into Equation 3.2 to calculate the two layer heights and they are found to be 0.2379 mm and 0.1889 mm, whereas they were designed to be 0.25 mm and 0.20 mm, respectively.

Note that this method does not automatically determine if there is more than one layer height present. The number of differing layer heights can be known before analysis. However, if given an unknown sample with multiple layer heights, a sudden change in the frequency of the ridge would indicate a change in layer height. That would allow for analysis to be performed assuming the number of layer heights present is indicated by the number of large changes in frequency.

### Layer Height as a Function of Depth

Inputting the moving mean of the frequency ridge into Equation 3.2, the layer height of the sample can seemingly be determined as a function of depth (i.e., time) into the sample. The moving mean can be used as it produces a smoother curve for analysis.

However, there are some problems present in this approach that become clear upon more thorough inspection. Recall that the first peak of the front wall signal is used as the zero (what is considered the top of the sample). With that in mind, the layer height is expected to change where the sample changes layer height as defined in the g-code used to print the sample and confirmed by the results from measurements performed using CT microscopy. However, the layer height change may seems to occur elsewhere due to ringing from the reflections that occur. Once that ringing dies out, the frequency for the layer height region dominates and the ridge moves to the associated frequency. This ringing can prevent the use of a layer height vs. depth plot from being reliably used. Both layer heights are present in the plot, but the layer height does not change at the expected depth and thus using this method for quantifying the specific depth at which the layer height changes does not seem to be viable.

### Layer Height Harmonics

With layer height measurements, an issue can arise in the methods presented thus far due to what is termed as “Layer Height Harmonics” for this disclosure. Layer height harmonics are a result of frequencies that are a factor of 2″, where n E [symbol] , off from another frequency associated with the layer height. When the harmonic factor is set to 1, n=1, the frequency associated with the layer height is considered the base frequency in this disclosure. For example, if the layer height is 0.2 mm and the speed of sound of your material is 2000 m/s, the corresponding base frequency would be 5 MHz. The hypothesis behind this phenomenon is that the nodes and/or antinodes of the ultrasonic waves line up on the interfaces between layer heights only at layer height harmonic frequencies. For most cases in this disclosure, the harmonic factor from Equation 3.2, n, has been set to 1. However, there are a few cases present in this disclosure in which the harmonic factor is set to 0, n=0, in order for an accurate measurement to be taken.

Through the inspection of a layer height sample with a layer height of 0.40 mm, it can be seen that changing the frequency of the transducer changes the measured layer height (while n=1). When measured with a nominal 5 MHz transducer, the measured frequency of 2.76 MHz results in a measured layer height of 0.4022 mm. However, when the same sample is measured with a nominal 7.5 MHz transducer, the measured frequency is about twice what is expected. The measured frequency ends up being 5.66 MHz, a little more than twice what was measured by the 5 MHz transducer, and the resulting measured layer height is 0.1961 mm. This difference in the measured layer heights indicates that frequencies that differ by a factor of 2 can be a result of the same layer height. Thus, the harmonic factor, n, was introduced into Equation 3.2 to address this inconsistency. For example, when using the 7.5 MHz transducer to measure the layer height of a 0.40 mm layer height sample, setting the harmonic factor to 0 results in a much more accurate layer height measurement of 0.3921 mm. From the observations made during this study, harmonic factors of 0 and 1 have been able to produce accurate results, but that conclusion is purely a function of the selected transducer and the corresponding layer height being inspected.

The existence of layer height harmonics makes it difficult to determine the layer height of a wholly unknown sample. For example, a 0.20 mm layer height sample and a 0.40 mm layer height sample would be measured to have nearly the same layer height. As was shown previously, with a nominal 7.5 MHz transducer, a 0.40 mm layer height sample can be measured to have a layer height of 0.1961 mm. With a nominal 7.5 MHZ transducer, a 0.20 mm layer height sample has been measured to have a layer height of 0.204 mm. The difference in measurement between the two samples is minor, which is a result of a layer height harmonic of the 0.40 mm sample being measure and causes the measured layer height to be off by a factor of 2. Both samples could be measured to have the same measured layer heights purely due to layer height harmonics. This indicates that for this method of measurement to be of value, the layer height should be roughly known within a factor of 2 of the true measurement in order to inform the selection of the transducer frequency and harmonic factor.

This raises some complications when determining the layer heights present in samples with changing layer heights. For example, in a sample with layer heights of 0.35 mm and 0.20 mm present, it is necessary to use a nominal 7.5 MHz transducer to accurately measure the layer height of the 0.20 mm section of the sample while keeping the harmonic factor set to one. However, in this sample, a harmonic of the expected frequency for the 0.35 mm section presents itself. The frequency in the 0.35 mm section of the sample is approximately 6.37 MHz and the resulting measured layer height, with n=1, is 0.184 mm. That is a little more than half the expected layer height of 0.35 mm. The harmonic of the 0.35 mm sample results in an inaccurate measurement for that portion of the sample. However, if a 5 MHz transducer was used, with n=1, while the 0.35 mm section would have a more accurate measurement, the 0.20 mm portion of the sample would lose accuracy.

Layer height harmonics play a large role in the efficacy of the method presented in this disclosure. It is a factor that must be kept in mind when this method is used for measuring the layer height of additively manufactured components. There must be some prior knowledge of the part or sample that would be inspected with this method in order to avoid inaccuracies in measurements.

### Missing Extrudate Visualization in Additive Manufacturing

This section investigates samples that have a region of missing extrudate. This could be cause in production due to a small, entrapped bubble, or slippage in the extruder, but regardless this defect would be a point of potential failure in structural loading. Using the WSST, this section provides results to demonstrate that it is possible to visualize a missing extrudate in an additively manufactured sample. The process for doing this begins with the ridge from the WSST of every a-scan collected during a scan of the sample. In order to smooth out the ridge to aid in analysis, a moving mean of the ridge is taken using MATLAB's built in movmean function or other suitable functions. The moving mean is taken using 10 points before the point in question and 10 points after the point in question.

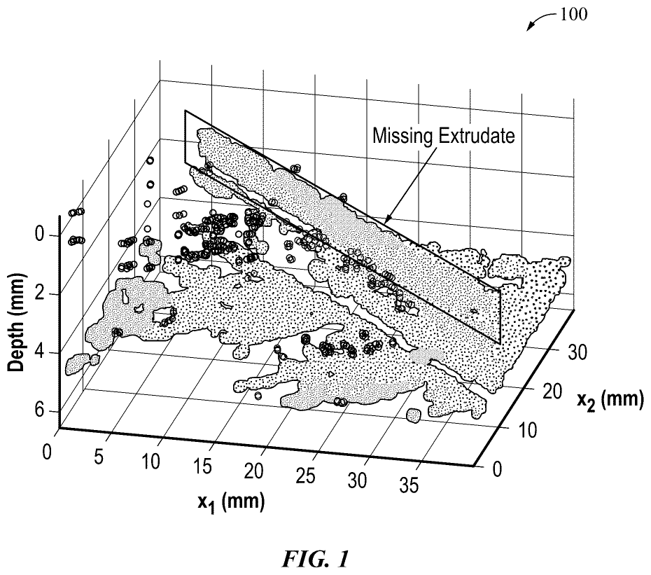

Once the smoothed frequency ridge of every a-scan is created, it is possible to visualize the missing extrudate by simply isolating frequencies associated with the missing extrudate. The missing extrudate can be identified in a gated c-scan based on the frequency present in the region with the missing extrudate. This frequency has been observed to typically be higher than the frequency throughout the remainder of the sample. Specifically, it is observed that for the part inspected if only points with a frequency in the range between 3.55 MHz and 3.8 MHz are shown, the missing extrudate is easily visualized as shown in FIG. 1, which is a visualization of missing extrudate that is configured to allow a user to accept or reject a scanned component, in accordance with an example embodiment of the present disclosure.

FIG. 1 shows those points within the expected frequency range for a missing extrudate indication. The region associated with the missing extrudate is marked in FIG. 1. In this case the data is from a sample with the missing extrudate in the 5th layer. The region marked in FIG. 1, which is associated with the missing extrudate, begins at a depth of approximately 1.6 mm. The missing extrudate is located in layer 5, which means the void caused by the missing extrudate would start at a depth of 1.4 mm and end at a depth of 1.75 mm within the sample. The difference in depth between the results from the WSST based method and the expected depth could be a result of either or both the moving mean causing a delay in which a certain frequency is reached and the WSST itself causing a small shift in the time scale, which would line up with other observations such as the maximum magnitude in the WSST occurring after the maximum magnitude in the original a-scan. With the isolation of frequencies, the missing extrudate can be identified and visualized within the additively manufactured sample.

### Wrinkle Visualization in Carbon Fiber Reinforced Polymer Laminates

Using a similar method as laid out previously, it is possible to visualize wrinkles in CFRP laminates, after the scanning has been performed and the data has been processed. For a sample 127 mm×177.8 mm×6.23 mm panel made with plain weave carbon fiber fabric, the lay-up was composed of all 0° layers with 28 total layers (i.e., [0]28). During the lay-up process, two tows of unidirectional carbon fiber were inserted between layers 13 and 14 to produce two wrinkles in the sample. Starting with the scan data, the general analysis steps laid out previously were performed on the data for preprocessing. The smoothing window size was 9-by-9 for the smooth2a function. For the purposes of analysis detailed in this section, the speed of sound of the CFRP laminate material system being used is 2890 m/s [56].

With the data preprocessed, the procedure for identifying the first ridge as is performed on every a-scan in the data set for the CFRP laminate. For example, an a-scan of a CFRP with an embedded wrinkle is not clear from the traditional approach for ultrasound inspection, but using a similar method as laid out in previously, it is possible to visualize a wrinkle in CFRP laminates. The WSST with the first ridge overlaid can be seen in, and the ultrasonic signal from a CFRP laminate has a much more complex time-frequency profile compared to those from the additively manufactured samples. However, the wsstridge function is still able to identify the first ridge and can be used for analysis.

For wrinkle analysis, every a-scan's ridge can be plugged into the movmean function with the previous 10 points and following 10 points being used for the moving mean. This is for smoothing the ridge to remove any sudden jumps in the frequency of the ridges. The smoothed ridge is then plugged into Equation 3.2 to find the layer height as a function of time. This is then repeated for each a-scan collected for the wrinkle sample, to transform the raw ultrasonic b-scan into a layer height b-scan by going through the WSST layer height analysis process.

With the layer height as a function of depth for every a-scan, the CFRP wrinkle sample can be digitally reconstructed to visualize the part and the wrinkle present in the sample. To start this process, first the beginning of the reconstruction must be defined. The front wall signal has a time-frequency content that results in the ridge switching the frequency in that zone between neighboring a-scans. Thus, the beginning of the reconstruction is placed after the front wall an amount of 0.4 mm, which corresponds to 4 lamina into the part. This removal of the initial 3 lamina from the signal allows for the processing to be smoothed and this a better quantification of the layer height is observed. This time to start the rebuild is manually chosen based on when the layer height settles out in the layer height b-scan.

From the starting point in depth of 0.4 mm and at x₁=0 mm, the first layer for the rebuilt sample is initially generated. In order to do this, the nearest absolute peak to 0.4 mm in the a-scan at x₁=0 mm is found and selected as the start of the first layer. Then 7 points in the depth direction, centered on the start of the first layer with 3 points above the start of the first layer and 3 points below the start of the first layer, in the next step in the x₁ direction is evaluated to find the point with the highest amplitude in the next step in the x₁ direction. That next point in the next x₁ direction is then used as the starting location for determining the point in the following step in the x₁ direction. This process is repeated for every step in the x₁ direction until the first layer is reproduced based on the peak of the reflection from that layer. The first layer of the reconstruction is not associated with the first layer of the CFRP laminate and is instead associated with the 4^{th} layer of the laminate. This is a result of the first portion, 0.4 mm, of the ultrasonic signal being ignored because of the front wall frequency ridge issue discussed earlier.

After the first layer is produced in the b-scan, the rest of the layers are rebuilt within each a-scan. The following process can be performed on a singular a-scan or on all the a-scans in a b-scan because the result from one a-scan does not affect any other a-scans. To start rebuilding the part for an a-scan, start from the first layer of the reconstruction. From this point, each following point in time is evaluated in the following manner. First, the mean layer height in the time range from the starting point to the current evaluation point is found. Next, the time difference between the starting and evaluation points is used to calculate the distance between the two points in physical space using Equation 3.1.

The calculated distance is then compared to the mean layer height for the time range currently being evaluated. If the calculated distance is greater than or equal to the mean layer height, then the evaluation point is considered the next layer. Then this process is repeated from the new layer's location. This is repeated until the mean layer height increases above a value of 0.4 mm. This cut off value is used as it is known that measured layer heights of that value are only produced when the ridge finding is either inaccurate or the signal has attenuated to the point that only a small, low frequency, portion of the signal is left.

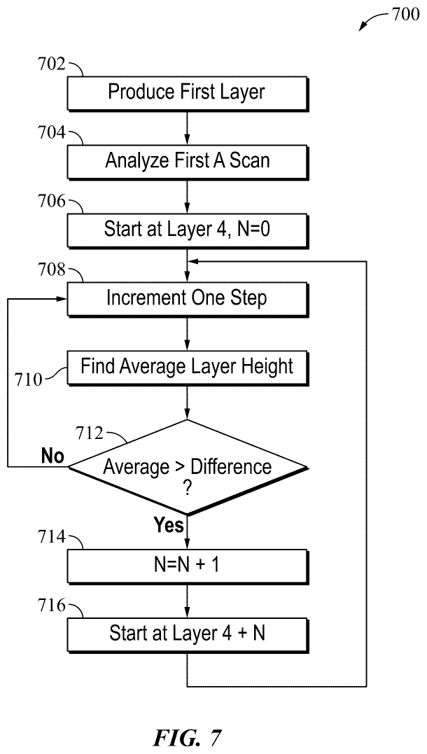

FIG. 7 is a diagram of a process for analyzing ultrasound data, in accordance with an example embodiment of the present disclosure. At 702, a first layer is produced. At 704, a first scan is analyzed. At 706, the process goes to layer 4. At 708, the process increments one step. At 710, the average layer height is determined. At 712, it is determined whether the average is greater than a predetermined difference, if no the process returns to 708, otherwise it proceeds to 714 where the counter is incremented. The process them proceeds to 716 where it starts at layer 4+N/.

From the raw rebuilt part, a cleaner rebuild can be produced. Due to the cross tow included in the sample during manufacturing, there is an extra “layer” present in the section with the wrinkle. As such, one portion of the line must be excised from the line for each wrinkle to account for the reflection that the cross tow produces in the ultrasonic signal. This is performed by the user manually selecting the ends of the portion to be excised. That portion is then turned into its own separate line in the reconstruction. The reconstructed layers are then cleaned up by removing any layers that do not have points on both ends on the b-scan. The result of this excision and cleanup can be seen in a much cleaner rebuild of the part after all the layers are rebuilt with the two excised parts from the two cross tows removed from their original lines.

If this process is repeated, without the step excising the reflection from the cross tows, for every b-scan collected in a part scan, a 3D representation of the part can be produced. Individual layers or multiple layers together can be visualized from the rebuilt sample data produced in this way. While the goal of this disclosure is not to define the size of the wrinkle, it is clear that the method presented can be used to identify the shape of the wrinkle by visual inspection of this data output. Further analysis could be performed from this point to define the wrinkle more fully.

Porosity characterization was studied. A first study related an extrusion multiplier to a change in porosity and a second study related the exponential coefficient to change in porosity. The change in porosities, as calculated using Equation 2.4 based on density measurements according to ASTM D792-20 [54], was found for 15 samples with extrusion multipliers varying from 0.99 to 0.95. The samples were produced with the intention of having varying density, and thus a varying change in porosity, by changing the extrusion multiplier in the print parameters. Recall that extrusion multiplier adjusts the amount of material extruded for the same path traveled. Nine samples with varying changes in porosity were evaluated using the ultrasonic analysis method described herein. The results show a correlation between an increasing change in porosity and an increasing the value of the exponential coefficient.

Four studies were performed using the WSST to quantify layer height. The first study investigated the ability to measure the layer height of samples with a singular layer height using the dominant frequency in an ultrasonic signal to calculate the layer height, and showed good results with percent errors under 7%. The second study investigated the potential to measure two layer heights in samples designed with two layer heights, and showed promise with percent errors 6% for both layer heights in the two samples investigated. The third study investigated the ability to measure layer height as a function of depth by using the frequency ridge extracted from the WSST to produce a layer height curve for a sample with two layer heights, and revealed that frequency might not be able to be used for determining at what depth the layer height changes. The fourth study compared the results from the second study to measurements performed using CT microscopy. The two methods show good agreement with percent differences below 6%. Ultimately the methods presented in this disclosure showed great promise and high accuracy for measuring layer height in FFF manufactured parts.

A study using the WSST to extract a frequency ridge from every a-scan in a raster scan was performed and used to visualize a missing extrudate within layers with missing extrudates at varying depths. The study showed promise as the missing extrudate was able to be visualized in all three samples by isolating frequencies between 3.55 MHZ and 3.8 MHz. The depths were also able to be measured using the MATLAB plots with percent errors all below 12%. The study showed good promise for the WSST being a useful tool in identifying missing extrudates in FFF manufactured parts.

A study using the WSST to extract a frequency ridge which is then used to calculate the layer height as a function of depth for b-scans and c-scans of CFRP laminates samples with wrinkles for the purpose of digitally reconstructing the sample was performed. The first 3 layers of the sample were not able to be reconstructed with the proposed method due to issues with the front wall signal. However, the method successfully reconstructed layer 4-13 in both of the scans. As layer 13 is the last layer before the cross tow that causes the wrinkle is present, the method shows great promise as it can visualize the wrinkle in the specimen accurately in the two cases investigated.

### Change in Porosity in Fused Filament Fabrication

The efficacy of using the STFT for the detection of inter-bead porosity was investigated. The goal of the proposed method was to characterize porosity using ultrasound without the need for a back wall signal to be present by determining the how porosity affects the attenuation of a wide band of frequencies. Two studies were performed. The first investigated the effect the extrusion multiplier value had on the change in porosity. The second investigated the correlation between exponential coefficients and the change in porosity.

All samples used for the porosity studies were designed to have dimensions of 3 in×3 in ×0.25 in (76.2 mm×76.2 mm×6.35 mm). The samples used for these studies are intended to have varying porosity. This variation in porosity was accomplished by adjusting the extrusion multiplier in a range of 0.95 to 0.99. The extrusion multiplier changes the flow rate of material during the manufacturing process by the extrusion multiplier factor. The samples are named like such, 0.99_Ext_Mult_001, in which the first number is the extrusion multiplier, the “Ext_Mult” moniker labels it as an extrusion multiplier sample, and the final number is the sample number. Every scan of the porosity samples was performed with a 5 MHz flat faced transducer with a scan area of 40 mm by 40 mm and resolutions of 0.2 mm and 0.2 mm in the x₁ and x₂ directions respectively. A c-scan (raster scan) was performed on every sample. Signal averaging was applied during the scan by averaging 4 a-scans for every a-scan collected.

The value that was tracked with the intention of being of use in characterizing porosity was the exponential coefficient present in the curve fit to the STFT magnitude frequency cutoff plot. The exponential coefficient was found by setting a threshold magnitude and finding the highest frequency that passes that threshold at each time step. The resulting curve was then fit to an exponential function F=Ae^{-Bt} where F is in Hz, t is in s, and B is in s⁻¹. The exponential coefficient, B, was determined. For each scan performed on the samples, the exponential coefficient was calculated for each a-scan collected in the scan. The average exponential coefficient of each scan was then calculated along with its corresponding standard deviation.

The density of the porosity samples was measured using ASTM D792-20. The density was used to calculate the change in porosity using Equation 2.4 in order for a more accurate investigation of the exponential coefficient's relationship with the porosity of the samples. The change in porosity was calculated rather than porosity itself as it is calculated by comparing the density of the manufactured sample to the raw PCTG density value provided by Essentium. As such, any porosity already present in the raw material could still be present in the final sample, so the change in porosity is what is presented in these results.

It was observed during the ASTM D792-20 measuring process that the samples slightly changed in weight over the course of the five measurements taken for each sample. While each sample was submerged in water for no more than 45 seconds during each measurement, it is possible that during that time, water seeped into inter-bead pores that were open to the surface of the sample. In between each measurement, the samples were allowed to dry for no less than one minute. However, it is possible that not all the water left the sample prior to following measurement resulting in the observed increase in mass over the course of the study.

The summary of results from all porosity samples is shown in Table 4.1. Table 4.1 shows the sample name along with the average measured density of the sample and the standard deviation of the density measurements. Also present is the calculated average change in porosity and the calculated standard deviation in the change in porosity.

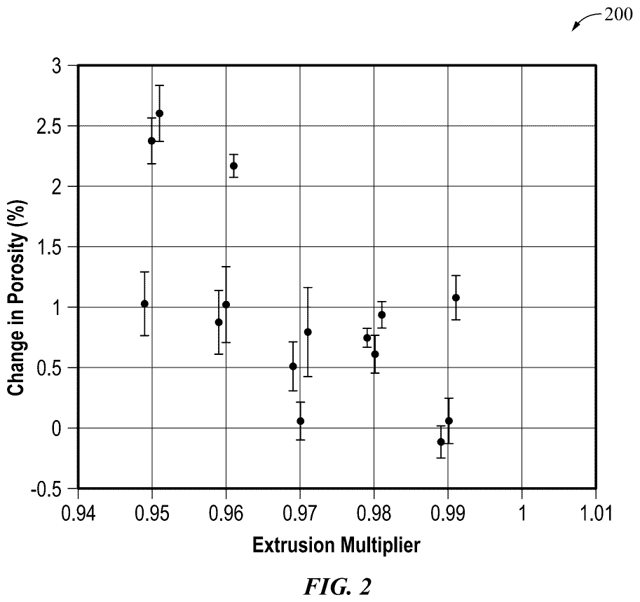

FIG. 2 is a visualization of a change in porosity that is configured to allow a user to accept or reject a scanned component, in accordance with an example embodiment of the present disclosure. FIG. 2 shows the change in porosity plotted as a function of extrusion multiplier from the values present in Table 4.1. The error bars present in FIG. 2 represent twice the standard deviation of the change in porosity. Also, for clarity, the values used to plot on the extrusion multiplier axis were slightly modified to prevent any points and error bars from overlapping. The extrusion multiplier value, rounded to the hundredths place, that is closest to the point is the extrusion multiplier associated with that data point. From FIG. 2, it can be seen that while the extrusion multiplier does affect the change in porosity of the sample, it does not consistently affect the change in porosity. The only extrusion multiplier with consistent results are samples with a 0.98 extrusion multiplier in which the change in porosity was between 0.4% and 1.1% for all three samples. All other extrusion multipliers have a much greater variance among the samples.

One sample presents a negative average change in porosity. While initially this may seem impossible, it is important to notice that a positive change in porosity value is within two standard deviations of the average, so it is within reason to believe that the true change in porosity of this sample is indeed positive. However, there are other possibilities that could be resulting in a negative measured change in porosity. First, as mentioned prior, the density measurements may have been slightly above the true value due to water from the measurement process filling in pores that were open to the surface of the sample and causing an overall increase in measured density. Secondly, the material density value used in the porosity calculations was provided by Essentium and only 3 significant figures were provided for that value. The sample with the negative average porosity would in fact have the same density as that reported by Essentium if the value was rounded to 3 significant figures. As such, there is a plausible explanation for a negative average change in porosity, though it is possible, based on the standard deviation, that the true change in porosity is positive none the less.

TABLE 4.1
Change in porosity study results. The average density along with its standard
deviation is presented along with the corresponding change in porosity values.
The exponential coefficient and its standard deviation is also presented for
samples that were scanned as part of the porosity characterization study.

| | | | | Standard | | |
|---|---|---|---|---|---|---|
| | | | | Deviation | | Standard |
| | | Standard | Average | of the | | Deviation |
| | | Deviation | Change | Change | Average | of the |
| | Average | of the | in | in | Exp. | Exp. |
| | Density | Density | Porosity | Porosity | Coeff. | Coeff. |
| Sample Name | (kg/m³) | (kg/m³) | (%) | (%) | (s⁻¹) | (s⁻¹) |
| 0.99_Ext_Mult_1 | 1216.67 | 1.12 | 1.08 | 0.09 | 0.212 | 0.012 |
| 0.99_Ext_Mult_2 | 1229.17 | 1.12 | 0.07 | 0.09 | 0.162 | 0.012 |
| 0.99_Ext_Mult_3 | 1231.31 | 0.82 | −0.11 | 0.07 | N/A | N/A |
| 0.98_Ext_Mult_1 | 1218.37 | 0.68 | 0.95 | 0.06 | 0.174 | 0.009 |
| 0.98_Ext_Mult_2 | 1222.36 | 0.96 | 0.62 | 0.08 | 0.172 | 0.003 |
| 0.98_Ext_Mult_3 | 1220.68 | 0.47 | 0.76 | 0.04 | N/A | N/A |
| 0.97_Ext_Mult_1 | 1220.13 | 2.30 | 0.80 | 0.19 | 0.172 | 0.010 |
| 0.97_Ext_Mult_2 | 1229.17 | 0.99 | 0.07 | 0.08 | N/A | N/A |
| 0.97_Ext_Mult_3 | 1223.60 | 1.23 | 0.52 | 0.10 | N/A | N/A |
| 0.96_Ext_Mult_1 | 1203.25 | 0.59 | 2.17 | 0.05 | 0.221 | 0.014 |
| 0.96_Ext_Mult_2 | 1217.38 | 1.95 | 1.02 | 0.16 | N/A | N/A |
| 0.96_Ext_Mult_3 | 1219.10 | 1.64 | 0.89 | 0.13 | N/A | N/A |
| 0.95_Ext_Mult_1 | 1197.92 | 1.44 | 2.61 | 0.12 | 0.281 | 0.006 |
| 0.95_Ext_Mult_2 | 1200.72 | 1.17 | 2.38 | 0.10 | 0.243 | 0.015 |
| 0.95_Ext_Mult_3 | 1217.27 | 1.65 | 1.03 | 0.13 | 0.150 | 0.012 |

Not all porosity samples were scanned with ultrasound as not all samples were needed for the porosity characterization study. As such, in Table 4.1 only samples scanned have average exponential coefficients and the standard deviation of the exponential coefficients provided. All other samples have N/A filled in that portion of the table. The overall average exponential coefficients for each sample are calculated by averaging the average exponential coefficients from each scan performed on that sample. The overall standard deviation of the exponential coefficients for each sample are calculated by averaging the standard deviations of the exponential coefficients from each scan performed on that sample. However, the math for the average of standard deviations is not the same as the average of other values; it is instead calculated using Equation 4.1 below.

$${s}_{a v g} = \sqrt{\frac{{s}_{1}^{2} + {s}_{2}^{2} + … + {s}_{k}^{2}}{k}} \qquad ( 4.1 )$$

In Equation 4.1, s_{avg} is the average standard deviation, sₙ is the standard deviation of scan n, and k is the total number of scans.

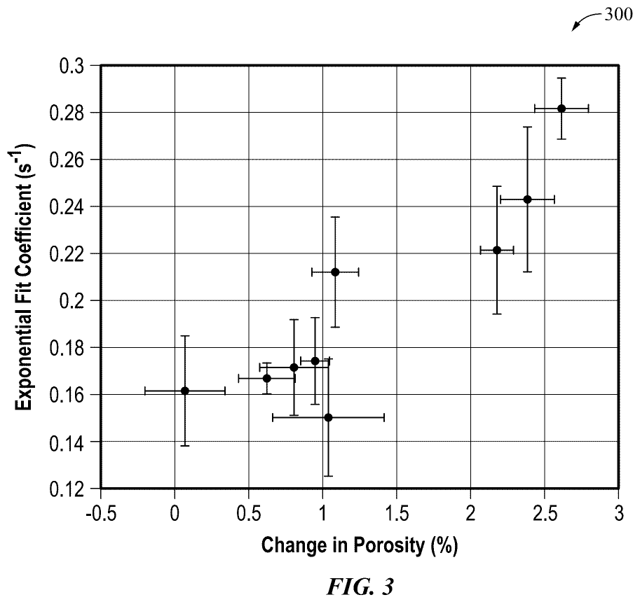

FIG. 3 is a visualization of a change exponential coefficient as a function of porosity that is configured to allow a user to accept or reject a scanned component, in accordance with an example embodiment of the present disclosure. The overall average exponential coefficient for each sample is plotted against the change in porosity in FIG. 3. The vertical error bars represent twice the standard deviation of the exponential coefficient and the horizontal error bars represent twice the standard deviation of the change in porosity. From FIG. 3, it can be seen that there is a general correlation between the exponential coefficient and the change in porosity. Generally low changes in porosity are associated with lower exponential coefficients and higher changes in porosity are associated with higher exponential coefficients. As can be seen in FIG. 3, there are two clusters of data that are easily distinguishable. For example, the sample with a 2.61% change in porosity, with an average exponential coefficient of 0.281 s⁻¹, is easily distinguishable from a sample with a 1.03% change in porosity, with an exponential coefficient of 0.150 s⁻¹. This shows that the presented method has potential for use in characterizing porosity.

This method is beneficial as it has no need of a backwall signal, unlike other methods for porosity characterization. The method works by considering the attenuation of a wide range of frequencies and measuring the rate of that attenuation as a function of frequency through the use of the exponential coefficient. The method can distinguish between small changes in porosity, in the example mentioned previously, there is only a 1.58% absolute difference between the average changes in porosity between the two samples with a 0.131 s⁻¹ absolute difference between the respective exponential coefficients. That is a small overall change in porosity with an appreciable change in the exponential coefficient. This shows promise as the method can distinguish small changes in porosity. This is an improvement on previous literature, as the changes in porosity considered are much smaller (all within a 3% change in porosity) compared to results from other literature that considered changes in extrusion multiplier of at least 0.10 (e.g., a change in the extrusion multiplier from 1.00 to 0.90), which would indicate greater changes in porosity that was considered in the present study.

The method presented in this work for porosity characterization does have limits, however. First, it is difficult to distinguish changes in porosity as is evident in FIG. 3. the cluster with changes in porosity between 0% and 1.5% overlap with error to the point that it would be difficult to determine the specific change in porosity of any sample with an exponential coefficient between 0.12 and 0.195 s⁻¹. Another possible issue with this method is the high frequency range that is considered during analysis. Everything from 0 to 50 MHz is considered during analysis, which can be of concern as the transducer used for data collection has a maximum −6 dB bandwidth of 6 MHZ, way below the 50 MHz maximum range used for analysis. The results of the study are promising, but future work should consider other transducer frequencies to see if the overall trend of exponential coefficient increasing indicating an increase in the change in porosity is consistent for other transducer frequencies.

### Quantifying Layer Height in FFF

To test the efficacy of using the WSST to quantify layer height, multiple studies were performed. For all studies, a frequency ridge was extracted from the WSST to determine the dominant frequency as a function of time (i.e., depth into the part). Using that frequency ridge, in the first two studies, a method was developed to automatically create analysis regions, the number of regions depends on the study, in which the frequency associated with layer height is extracted. The layer height was then calculated based on Equation 3.2 for each analysis region. The first study considered samples with one designed layer height. The second study considered samples with two designed layer heights. The third study investigated using Equation 3.2 to determine layer height as a function of depth. The fourth study compares the results from the ultrasonic analysis method to the measurements taken in the CT scan as described herein.

The scan parameters used in the layer height studies were described previously. All samples in the first three studies were scanned using a b-scan (single pass). A 5 or 7.5 MHz flat faced transducer was used for every scan. The transducer used will be presented with the specific results. Signal averaging was applied during the scan by averaging 4 a-scans for every a-scan collected. Every a-scan collected in the scan was used to create an average a-scan which is then analyzed to determine the layer height.

All samples were manufactured as described previously. The samples were designed with outer dimensions of 3 in ×3 in ×0.25 in (76.2 mm×76.2 mm×6.35 mm). They were designed to have layer heights ranging from 0.20 mm to 0.40 mm with increments of 0.05 mm. For the first study, all of the samples had a single layer height for the whole of the sample. For all subsequent studies, samples were designed with two layer heights. The first layer height was designed to be present in the first 2 mm of the print and the second layer height was designed to be present from the 2 mm mark to the top of the part (6.35 mm).

### Single Layer Height Results

The first study involved the measurement of the layer height of samples with a singular layer height. Samples were printed with a singular layer height ranging from 0.20 mm to 0.40 mm in increments of 0.05 mm. Samples were named as such, LH_0.25_001, in which “LH” marks the sample as a layer height sample, “0.25” is the designed layer height, in this case it is 0.25 mm, and “001” indicates the sample number with the same layer height, which in this case is sample 1.

The information of the scans performed on each single layer height sample is given in Table 4.2. The transducer frequency is provided along with the harmonic factor, n, that is used for analysis of the associated scans. Some samples were scanned with two different transducers. In that case the scans that are associated with each transducer frequency is reported.

As described previously, single layer height samples were analyzed by taking the frequency ridge and automatically determining the region of the scan associated with the layer height of the sample. Once that region is determined, an average frequency is calculated from that region. That number is then plugged into Equation 3.2 along with the harmonic factor, n, to calculate the layer height of the sample.

TABLE 4.2
Scan information for single layer height samples with
nominal transducer frequency and the harmonic factor used.
For samples scanned with multiple transducers,
the scans associated with that transducer is listed as well.

| | Transducer | | Harmonic |
|---|---|---|---|
| Sample Name | Frequency (MHz) | Scans | Factor, n |
| LH_0.20_001 | 7.5 | N/A | 1 |
| LH_0.25_001 | 7.5 | N/A | 1 |
| LH_0.25_002 | 7.5 | N/A | 1 |
| LH_0.30_001 | 7.5 | N/A | 1 |
| LH_0.30_002 | 7.5 | N/A | 1 |
| LH_0.30_003 | 7.5 | N/A | 1 |
| LH_0.35_001 | 7.5 | 1-3 | 1 |
| | 5 | 4-5 | 1 |
| LH_0.35_002 | 7.5 | 1-3 | 0 |
| | 5 | 4-5 | 1 |
| LH_0.35_003 | 7.5 | 1-2 | 0 |
| | 5 | 3-4 | 1 |
| LH_0.40_001 | 7.5 | 1-3 | 0 |
| | 5 | 4-6 | 1 |
| LH_0.40_002 | 7.5 | 1-2 | 0 |
| | 5 | 3-4 | 1 |

The harmonic factor, n, is necessary to be used due to the effect of layer height harmonics. As described previously, layer height harmonics are a phenomenon in which the dominant frequency from the frequency ridge differs from the base frequency associated with the layer height by a factor of 2⁻⁽ⁿ⁻¹⁾. This often occurs when the harmonic is closer in value to the frequency of the transducer than the base frequency is. For the purposes of this work, a harmonic factor of 1, n=1, is associated with the base frequency. The harmonic factor used for each sample and transducer combination is presented in Table 4.2.

The measured layer height can be compared to the nominal layer height. A line that marks the ideal case in which the measured layer height matches the nominal layer height can be formed. The samples can have a measured layer height close to the designed layer height. The variance in the measurements can increase as the layer height increases. This can also be seen when considering the percent error from the measured layer height to the nominal layer height. The 0.2 mm sample had the least amount of variance between all of its scans. For scans using a harmonic factor of 1, the highest percent error was 5.19%. which was from a scan of a sample with a layer height of 0.4 mm. For scans with a harmonic factor of 1, the lowest percent error of 0.02% was from a 0.35 mm sample (LH_0.35_001) which was scanned by a 7.5 MHz transducer. That particular sample was a special case for 0.35 mm samples as a harmonic factor of 1 could be used on scans from a 7.5 MHZ transducer. Other 0.35 mm samples needed a harmonic factor of 0 on scans from a 7.5 MHZ transducer. For scans using a harmonic factor of 0, the maximum error was 6.06% for a 0.4 mm sample and the lowest percent error was 1.48% also from a 0.4 mm sample. For both the 0.35 mm and 0.40 mm samples, the scans with a harmonic factor of 0 are responsible for the least accurate measurements, but the greatest percent error is still only 6.06%, which is low.

As mentioned before, the 0.35 mm and 0.4 mm samples benefited from changing the transducer to a 5 MHz transducer. This was due to 7.5 MHz transducer scans resulting in a dominant frequency associated with half the expected measured layer height. It is interesting to note that with the exception of LH_0.35_001, the 0.35 mm and 0.4 mm samples needed the harmonic factor set to 0, n=0, to produce accurate results when scanned with the 7.5 MHz transducer. The sample LH_0.35_001 produced accurate results with the 7.5 MHz transducer with the harmonic factor still set to 1, n=1. The WSST of LH_0.35_001 had a strong response near 3.18 MHz and a weaker response near 6.34 MHZ while the WSST of LH_0.35_003 has a strong response in near 6.70 MHz and a weaker response near 3.43 MHz. For both samples, both harmonics were present, but the dominant frequency was shifted between the two samples, thus the output frequency ridge differs for both samples. Both samples were scanned with the same 7.5 MHz transducer and the two samples were fabricated on the same 3D printer with the same print settings, so it is unknown what causes a different response between the two samples. But it is important to highlight that both harmonics were observable from the 7.5 MHz data with the base layer height harmonic occurring near 3.5 Mhz. Thus, it is not surprising that both harmonics would be present In the signal and their relative energies would be similar. All of the samples were analyzed and have a typical percent error of 3% (ranging from 0.02% and 6.06%), thus showing that the frequency content of an ultrasonic scan of an additively manufacture component can be used to quantify the layer height.

From the results, it was seen that the method presented in this disclosure for measuring layer height shows promise. The accuracy of the method, while not exceptional, was adequate to show that this method is functional and enabling.

### Double Layer Height Results

The second study involved the measurement of the layer heights present in samples with two designed layer heights. Samples were printed with two layer heights with the first layer height being present from the base of the part (0 mm) to 2 mm above the base and the second layer height was designed to be present from 2 mm above the base to 6.35 mm, the designed top of the sample. The layer height information of both samples is presented in Table 4.3. Samples were named as such, LH_var_0.25_0.2, in which “LH_var” marks the sample as a double layer height sample, “0.25_0.2” is the designed layer heights, in this case it is 0.25 mm and 0.20 mm. Only one sample was made for each layer height combination so no sample number was needed.

TABLE 4.3
The layer heights present in double layer height
samples along with the regions in the sample that
the layer heights were designed to reside in.

| | | As | | As |
|---|---|---|---|---|
| | As | Designed | As | Designed |
| | Designed | Layer | Designed | Layer |
| | Layer | Height 1 | Layer | Height 2 |
| | Height | Region | Height | Region |
| Sample | 1 (mm) | (mm) | 2 (mm) | (mm) |
| LH_var_0.25_0.2 | 0.25 | 0-2 | 0.20 | 2-6 |
| LH_var_0.35_0.2 | 0.35 | 0-2 | 0.20 | 2-6 |

Both double layer height samples were scanned with a 7.5 MHz flat faced transducer. As described previously, double layer height samples were analyzed by taking the frequency ridge and automatically determining the two regions of the scan associated with the layer heights of the sample. Once the regions are determined, an average frequency from each region is calculated. Those frequencies are then plugged into Equation 3.2 along with the harmonic factors, n, to calculate the layer heights of the sample.

Both of the double layer height samples were scanned with a 7.5 MHz transducer as it was expected to be the best fit for both layer heights present in both samples. As discussed previously, harmonic factors other than 1 were sometimes necessary for samples with layer heights of 0.35 mm when scanned with 7.5 MHz transducer. As such, the layer height in the 0.35 mm region of LH_var_0.35_0.2 was calculated with a harmonic factor, as reflected in Table 4.4.

For both samples, the results using the method laid out herein are shown in Table 4.4. Table 4.4 presents the designed layer height and the measured layer height, along with the harmonic factor to calculate the measured layer height, and the percent error

TABLE 4.4
Results for the double layer height sample scans with
the measured layer heights along with the percent error of the
measurements compared to the as designed layer height.

| | | | As | | |
|---|---|---|---|---|---|
| | | | Designed | Measured | |
| | | | Layer | Layer | |
| | Scan | Harmonic | Height | Height | Percent |
| Sample | Number | Factor, n | (mm) | (mm) | Error |
| LH_var_0.25_0.2 | 1 | 1 | 0.25 | 0.2379 | 5.07% |
| | | 1 | 0.20 | 0.1889 | 5.86% |
| | 2 | 1 | 0.25 | 0.2381 | 5.01% |
| | | 1 | 0.20 | 0.1922 | 4.04% |
| LH_var_0.35_0.2 | 1 | 0 | 0.35 | 0.3484 | 0.46% |
| | | 1 | 0.20 | 0.1922 | 4.06% |
| | 2 | 0 | 0.35 | 0.3485 | 0.42% |
| | | 1 | 0.20 | 0.1895 | 5.57% |
| | 3 | 0 | 0.35 | 0.3487 | 0.38% |
| | | 1 | 0.20 | 0.1896 | 5.50% |

of the measurement. From Table 4.4 it can be seen that the 0.2 mm portion of both samples is measured with an error ranging from 4.04-5.86%. This error is within 3% of the error for single layer height samples with a layer height of 0.2 mm, which had a typical percent error of 3.2%. The 0.25 mm region from LH_var_0.25_0.2 is measured with a percent error ranging from 5.01% to 5.07%. This is within 2% of the error for single layer height samples with a layer height of 0.25 mm, which had a typical percent error of about 3%. The 0.35 mm region from LH_var_0.35_0.2 is measured with a percent error ranging from 0.38% to 0.46%. Recall that the layer height of the 0.35 mm region was calculated using a harmonic factor of 0, n=0. Compared to 0.35 mm single layer height samples scanned with a 7.5 MHz transducer and using a harmonic factor of 0, these results are vastly better by about 5% (those single layer height scans had a typical percent error of about 5.5%). Overall, it is clear that measuring two layer heights in a sample with two designed layer heights using the suggested method produces quality results with percent errors under 6%.

There was one scan of LH_var_0.25_0.2 that was not present in the results given in Table 4.4. This is because one of the scans had an error in the analysis region creation. This error was best discussed separately from the other results are they do not reflect the accuracy of the measurements, but instead reflect a possible flaw in the analysis method that should be addressed. As was seen in the analyzed WSST, the analysis regions were not located at the same depth as they are in the other scans of the same part. A first region was associated with the 0.25 mm region and was smaller than it is in other scans. Then a second region, which should have been associated with the 0.2 mm region of the sample, started right after the first region. This was unexpected when compared to the other samples. The region past the 2.75 mm mark, where the analysis region for the 0.2 mm region would be expected to appear based on other scans, had almost no frequency content of any kind. This results in an inaccurate placing of the analysis regions as the signal has attenuated past an analyzable amplitude. This was clearly an issue with this scan alone and was a result of bad data. As such, it is important to note that if the collected a-scans attenuate too much, proper analysis cannot be performed. This fact should be kept in mind when using the proposed method.

The results for LH_var_0.35_0.2 presented in Table 4.4 reveal a limitation with the current method. The harmonic factor needs to manually be set for every expected layer height region, otherwise inaccurate measurements can be made. As with the single layer height samples, the harmonic factor must be considered when using the proposed method for layer height calculation in double layer height samples. considered when measuring layer height in this way. As was discussed previously, it seems that having a rough estimate of the layer height prior to inspection is integral for producing accurate measurements as it is necessary to pick the correct transducer frequency and/or harmonic factor that best fits the expected layer height. As long as the guess is not off by a factor of 2, the correct layer height could be determined within 7% error as demonstrated in this work, at least with Essentium PCTG and with samples printed on the Essentium HSE 180 S HT with the method described previously. Future work could try to apply this method to new material systems and samples printed with other fused filament fabrication printers to test its validity in different conditions.

### Layer Height as a Function of Depth Results

The third study involved the measurement of the layer height as a function of depth within one two layer height sample, LH_var_0.25_0.2. The sample was printed with two layer heights with the first layer height, 0.25 mm, being present from the base of the part (0 mm) to 2 mm above the base and the second layer height, 0.2 mm, was designed to be present from 2 mm above the base to 6.35 mm, the designed top of the sample.

The sample was scanned with a 7.5 MHz flat faced transducer. Only one sample was considered for this study as it had two layer heights that did not need the harmonic factor to change for the measurement of different regions of the sample. As discussed previously, the harmonic factor for the two regions were different as a different harmonic order is present for the 0.35 mm region than the 0.2 mm region.

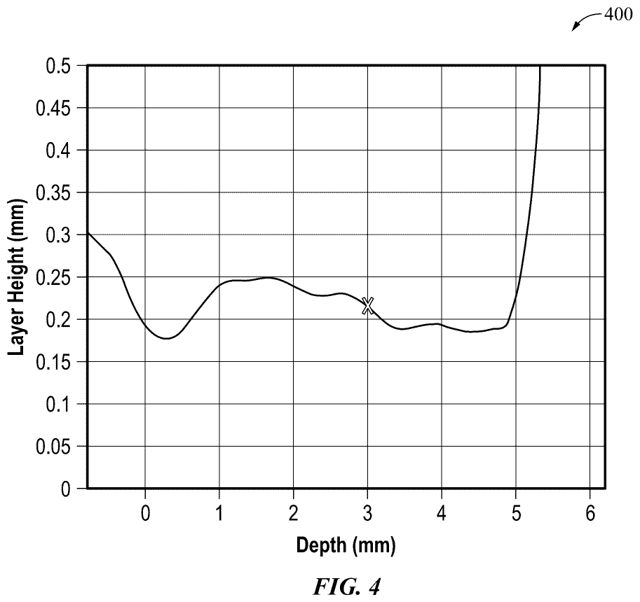

FIG. 4 is a visualization of layer height as a function of depth that is configured to allow a user to accept or reject a scanned component, in accordance with an example embodiment of the present disclosure. The moving mean of the frequency ridge can be directly converted into a layer height as a function of depth using Equation 3.2. The moving mean of the frequency ridge is fed through Equation 3.2 and the resulting plot is intended to show the layer height as a function of depth. The layer height as a function of depth results for the sample can be seen in FIG. 4. Just as was previously discussed, the sample has an issue with ringing that results in the layer height changing at the incorrect spot. The sample does not have the transition in the expected depth of 2 mm. Instead, the transition occurs deeper into the sample than anticipated. In the sample, the ringing seems to stop at a depth of about 3 mm. The ringing phenomenon requires more thorough investigation than is provided in this disclosure. As will be discussed, the ringing does not seem to affect gradual changes in layer height, but sudden changes in the layer height create a ringing effect that affects the accuracy of the measured layer height as a function of depth as seen in FIG. 4.

Another aspect of the layer height as a function of depth that should be considered is the sudden rise in “layer height” in the last part of the sample as can be seen in FIG. 4. This occurs as the dominate frequency suddenly drops when the signal attenuates past a certain point and a low frequency portion of the signal begins to dominate the signal and the ridge changes to reflect that change. This occurs in every layer height sample presented in this disclosure. Attenuation is a natural part of ultrasonics, and there are a variety of methods to address this issue. One option that is worth considering is using time-corrected gain during data collection to better capture the acoustic reflections from deep within the part.

### CT Layer Height Results

The fourth study involved the measurement of the layer height as a function of depth within one two layer height sample using CT microscopy. The measurements were performed as described, by taking a slice from the sample and measuring the distance between visible voids that marked the transition between layers.

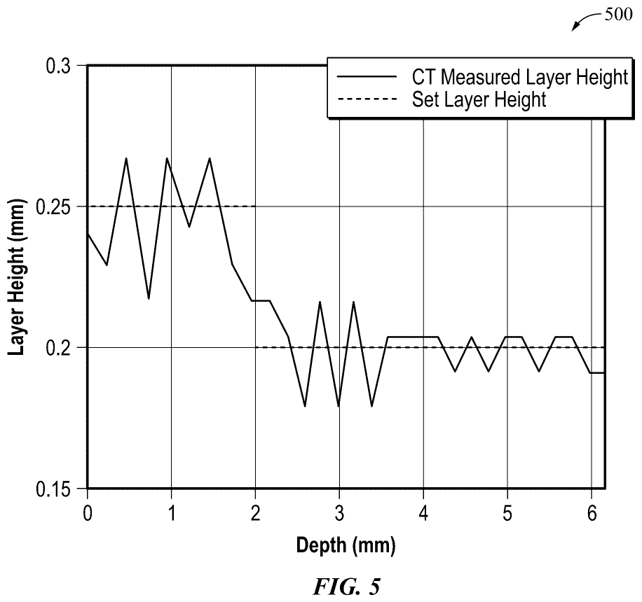

FIG. 5 is a visualization of layer height as a function of depth that is configured to allow a user to accept or reject a scanned component, in accordance with an example embodiment of the present disclosure. The results from the layer height measurements performed using CT microscopy are shown in FIG. 5, which shows the layer height as a function of depth in the part. The black line is the manual measurement from the CT data set and the red lines represent the as designed layer height within the sample. It is observed that the rolling average of the layer height from the CT data set follows the correct trend of the as manufactured layer height, but due to the voxel sizes there is considerable noise in the data.

The voxels from the CT scan are approximately 0.012 mm in size which limits the resolution of the measurements shown in FIG. 5. Also, the voids that were being used to mark the ends of layers are not of a uniform size, so measuring from layer to layer can result in different measured layer heights even if the true layer height is different.

However, despite these difficulties in measuring the layer height with the CT scan, the approximate layer height can still be quantified. As can be seen in FIG. 5, the measured layer height is similar to the as designed layer height but jumps at every layer. Because of this, using the CT measurements to determine layer height as a function of depth requires additional interpretation, the average layer height for each region was used. The average layer height for the 0.25 mm region was 0.242±0.021 mm while the average layer height in the 0.2 mm region was 0.1989±0.012 mm. These have percentage errors compared to the nominal layer heights

TABLE 4.5
Absolute and percent differences between the average
CT measurement results and the ultrasonic scan
results for measured layer height.

| | Nominal | Absolute | |
|---|---|---|---|
| Scan | Layer Height | Difference | Percent |
| Number | (mm) | (mm) | Difference |
| 1 | 0.25 | 0.0039 | 1.61% |
| | 0.2 | 0.0100 | 5.17% |
| 2 | 0.25 | 0.0037 | 1.53% |
| | 0.2 | 0.0067 | 3.44% |

of 3.29% and 0.54% respectively. The CT measurements had lower percent errors compared to the UT measurements with have percent errors ranging from 5.01% to 5.07% for the 0.25 mm region and 4.04% to 5.86% for the 0.2 mm region according to Table 4.4. So while the CT measurements are more accurate, the measurements from the proposed method in the second study for measuring layer height in samples with two layer heights are not far off from what was achievable with CT microscopy with a voxel size of 0.012 mm.

The percent difference and absolute difference from the CT values and the ultrasound values are all shown in Table 4.5. The percent difference for the 0.25 mm region ranges from 1.53% to 1.61% and the percent difference for the 0.2 region ranges from 3.44% to 5.17%. The 0.2 mm region is less close to the CT measured values, which makes sense as the measurement of the 0.2 mm region would be affected by the ultrasonic signal passing through the 0.25 mm region after reflecting in the 0.2 mm region, and would thus be less accurate. The absolute differences shown in Table 4.5 also show larger differences for the 0.2 mm region than the 0.25 mm region. Ultimately this shows that the proposed method from the second study presents accurate results compared to the measurements from the CT scan as the maximum absolute difference is 0.01 mm and the maximum percent difference is 5.17%, both low values.

### Visualizing Missing Extrudate in FFF

To show the potential for using the frequency ridge extracted from the WSST can be used to visualize a missing extrudate in a fused filament fabrication manufactured sample, a study was performed. For the study scans were ultrasonic scans were performed on samples that had a missing extrudate on variable layers. Three missing extrudate samples, with dimensions of 3 in×3 in×0.25 in (76.2 mm×76.2 mm×6.35 mm) and a layer height of 0.35 mm, were produced by editing the g-code to prevent the 3D printer from extruding for one line on a chosen layer as described. The information on which layers the missing extrudate was located on is presented in Table 4.6. The naming convention used for missing extrudate samples is as such.

The three missing extrudate samples were scanned using a 5 MHz spherically focused transducer. All of the scans were performed over a 40 mm by 40 mm scan region with a scan resolution of 0.2 mm in both the x₁ and x₂ directions. A c-scan (raster scan) was performed on every sample. A time corrected gain was applied to the scans with the goal of counteracting attenuation and aiding in the analysis process. Signal averaging was applied during the scan by averaging 4 a-scans for every a-scan collected. Each sample was scanned three times, though do to the similarity of the results only one scan from each sample is presented in this disclosure.

As mentioned, the samples that were scanned each had a missing extrudate at a different layer height. Table 4.6 includes the sample name with the layer that has the

TABLE 4.6
Missing extrudate sample information
with the layer was designed to have a
missing extrudate along with the as designed
depth of that layer assuming the designed
layer height of 0.35 mm is accurate.

| | Layer with Missing | As Designed |
|---|---|---|
| Sample | Extrudate | Depth (mm) |
| ME_L4 | 4 | 1.05 |
| ME_L5 | 5 | 1.4 |
| ME_L8 | 8 | 2.45 |

missing extrudate along with the as designed depth of the missing extrudate. The expected depth of the missing extrudate is based on the layer height set in the print parameters, which is 0.35 mm. The expected depth is associated with the start of the layer in which the missing extrudate is located. For each part a visualization of the missing extrudate was produced as described. The visualization was performed by first acquiring the frequency ridges, which represents the dominant frequency as a function of depth, of every a-scan collected for the scan. Then every point within the designated frequency range of 3.55 to 3.8 MHz is plotted in 3D, essentially filtering out all other data points. Among the points plotted from that frequency range, the missing extrudate can be visualized. The measured depth of the visualized missing extrudate was identified manually within the 3D plots made with MATLAB. The plots identifying the indications from the signal that fall within the designated frequency range of 3.55 to 3.8 MHz are colored in a way that makes it easy to visualize the missing extrudate.

The visualization of the missing extrudate can be quite prominent. It can easily be identified visually from the other indications from the frequency filter. The missing extrudate can present itself as a solid mass shaped like a thin log. The indication associated with the missing extrudate began at a depth of approximately 1.13 mm for one sample. This differed from the expected depth by an absolute error of 0.08 mm and a percent error of 7.62%. Three scans of this sample were performed in total, and they all presented similar results.

The visualization of the missing extrudate for a second sample was also quite prominent. It could easily be identified visually from the other indications from the frequency filter. The missing extrudate presented itself as a solid mass shaped like a thin log. The indication associated with the missing extrudate began at a depth of approximately 1.42 mm. This differs from the expected depth by an absolute error of 0.02 mm and a percent error of 1.43%. Three scans of this sample were performed in total, and they all presented similar results.

The visualization of the missing extrudate for a third sample could also be seen and was quite prominent. It could easily be identified visually from the other indications from the frequency filter. The missing extrudate presented itself as a solid mass shaped like a thin log. The indication associated with the missing extrudate began at a depth of approximately 2.73 mm. This differed from the expected depth by an absolute error of 0.28 mm and a percent error of 11.43%. Three scans of this sample were performed in total, and they all presented similar results.

The proposed method for visualizing the missing extrudate can be used for visualization. The scans from all three samples were able to be analyzed to make the missing extrudate prominently obvious from visual inspection. The rough depth measurements made from the plots also showed promise as the largest error from the designed depth of the missing extrudate was 11.43%. The work in this disclosure differs greatly in approach from type of probe to frequency of the transducer to the analysis method.

The analysis method presented in this disclosure can use a more thorough method that automates the measurement of the depth of the missing extrudate, expanding to sizing the indication and accurately identifying the depth at which it occurs. The capability of determining the frequency that is best associated with the missing extrudate indication can or alternatively also be used.

### Wrinkle Visualization in Carbon Fiber Reinforced Polymer Laminates

To investigate the potential for extending the layer height as a function of depth analysis for the visualization of wrinkles in CFRP laminates, a small study was performed. Only one sample was considered for this study as there was only one readily available sample with scans with quality scan data.

The sample was 127 mm×177.8 mm×6.23 mm panel made with plain weave carbon fiber fabric. The lay-up was composed of all 0° layers with 28 total layers (i.e., [0]₂₈). During the lay-up process, two tows of unidirectional carbon fiber were inserted between layers 13 and 14 to produce two wrinkles in the sample. The sample was manufactured using a wet layup process and used a hot press to aid in the curing process. Two scans of the same sample is considered for this study. The scans were performed as described previously. Both scans were performed over a region 125 mm×10 mm in size (x₁×x₂) with a resolution of 0.2 mm in both the x₁ and x₂ directions. The scans were performed with a spherically focused 7.5 MHz transducer with a time corrected gain applied. A c-scan (raster pattern) was performed for both scans. Smoothing was performed on the a-scans using smooth2a with an area of 9 by 9 samples.

The visualization used the frequency ridge to produce a layer height as a function of depth of either every a-scan in a b-scan, for a 2D reconstruction, or for every a-scan in a c-scan, for a 3D reconstruction. In both cases, the first 0.4 mm of depth is ignored for reconstruction as the front wall signal does not reflect the layer height accurately, this removes the first three layers from the reconstruction. Then the first layer is reconstructed by tracking the peak of the ultrasonic signal. Once the first layer is reconstructed, all subsequent layers are reconstructed based on the calculated layer height as a function of depth.

The results from the first scan show the two wrinkles that are present in the part. The reconstructed form of layer 13, which is the last layer before the cross tows that case the wrinkles, can be seen. Both wrinkles are clearly visible. There was a small issue in the layer in the region bounded by the edge of the scan, the 9.4 mm mark in the x₁ direction and the 9.6 mm mark in the x₂ direction. This same issue was present in every prior reconstructed layer. This means the issue was due to an issue with the peak tracking of the algorithm rather than the reconstruction method. It could be seen that the wrinkle was visualized in every layer that was reconstructed up to and including layer 13, with the wrinkle increasing in intensity. The b-scan with the reconstructed layers were also well-constructed. After the fiber tow, placed between layers 13 and 14, the reconstruction suffers. This is mainly due to attenuation causing the correct frequency associated with the true layer height of the CFRP laminate to die out, and thus causing the frequency ridge to change to other frequencies. Essentially, the quality of the original a-scans is the cause of the loss in detail after the primary wrinkle layer. This is expected as the quality of the data is important for any type of data analysis.

The results from the second scan also showed the two wrinkles that were present in the part. The layer close to the initiation of the wrinkles was layer 13. Both wrinkles awereclearly visible. However, there is some noise near the wrinkle this could be a result of small inaccuracies near the wrinkles in a few layers adding up as the reconstruction is performed. It was seen that the reconstruction follows the positive peaks up to the cross tows inserted below layer 13. There were a few inaccuracies from the wrinkle on the right on layers 10, 11, and 12, but the overall shape of the wrinkles could be seen and the intensity of the reconstructed wrinkles can be seen to increase with depth. It could be seen that past layer 13 the tracking became less accurate under the wrinkles, though the rest of layers 14 and 15 are well reconstructed outside of the wrinkle areas. Past that there are no reconstructed layers, except for a portion of layer 16, as subsequent layers were removed when the reconstruction was cleaned up to only include layers that span most of the b-scan.

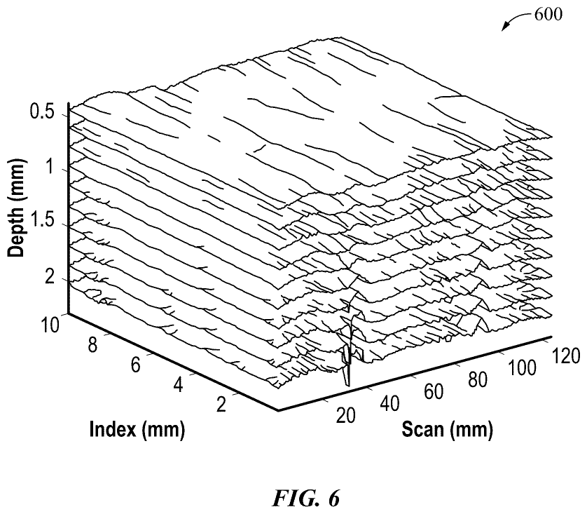

FIG. 6 is a visualization of geometry of a wrinkle that is configured to allow a used to accept or reject a scanned component, in accordance with an example embodiment of the present disclosure. As can be seen in FIG. 6, the 3D reconstruction for reconstructed layers 4 to 13 show the reconstructed geometry of the wrinkle. There is also a third wrinkle-like feature that can be seen in FIG. 6 between 0 and 30 mm in the x₁-direction. This feature does not change in intensity like a wrinkle would, so it is just a feature resulting from the tracking of the 4^{th} layer and is then carried through the rest of the reconstruction.

From both scans it can be seen that the method for wrinkle visualization proposed in this disclosure has potential. The front 3 layers cannot be tracked with this method due to limitations resulting from the front wall frequency not reflecting the layer height of the laminate. The proposed method can visualize wrinkles and has the potential to be further developed in the future for wrinkle characterization in CFRP laminates.

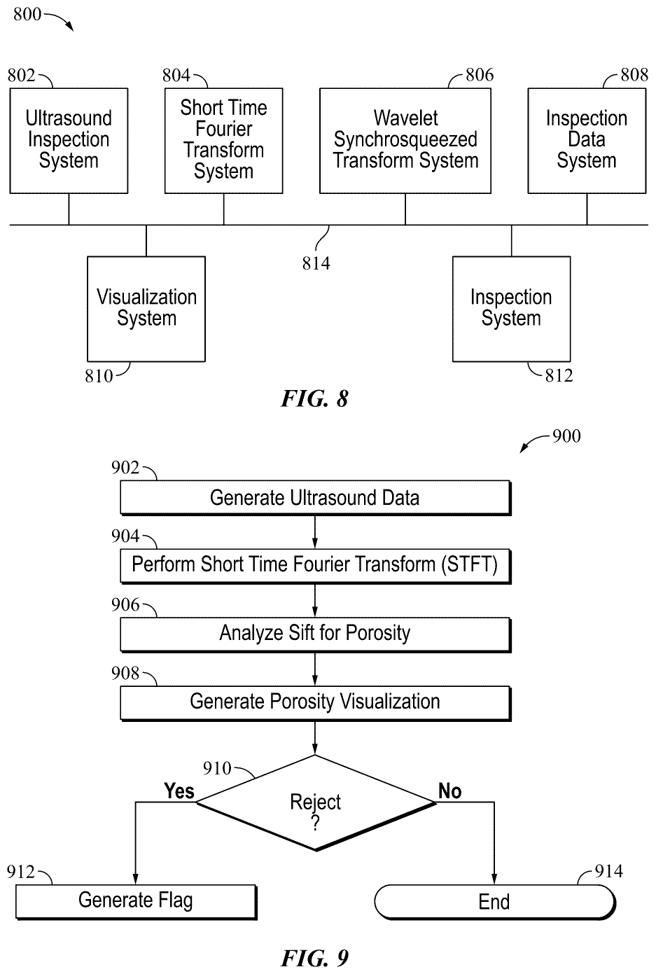

FIG. 8 is a diagram of a system 800 for ultrasound data analysis, in accordance with an example embodiment of the present disclosure. System 800 includes ultrasound inspection system 802, STFT system 804, WSST system 806, inspection data system 808, visualization system 810 and inspection system 812, each of which can be implemented in hardware or a suitable combination of hardware and software and can be coupled to communications medium 814.

Ultrasound inspection system 802 can be implement as one or more lines of code stored in a data memory that are loaded into working memory of a processor to cause the processor to be configured to use data generated by immersion scanning with a pulse echo setup, or data generated by other suitable ultrasound inspection systems as discussed and disclosed herein. In one example embodiment, ultrasound inspection system 802 can digitize an acoustic waveform generated by a receiving transducer, as opposed to only gated values of ultrasound data. The ultrasound data can be provided to other component systems of system 800 over communications medium 814.

STFT system 804 can be implement as one or more lines of code stored in a data memory that are loaded into working memory of a processor to cause the processor to be configured to perform STFT analysis of ultrasound data, as discussed and described herein.

Wavelet synchrosqueezed transform system 806 can be implement as one or more lines of code stored in a data memory that are loaded into working memory of a processor to cause the processor to be configured to performs WSST analysis of ultrasound data, as discussed and described herein.

Inspection data system 808 can be implement as one or more lines of code stored in a data memory that are loaded into working memory of a processor to cause the processor to be configured to receive and store ultrasound data, as discussed an described herein.

Wrinkle visualization system 810 can be implement as one or more lines of code stored in a data memory that are loaded into working memory of a processor to cause the processor to be configured to receives STFT data and WSST data and to generate visualization data for identification of porosity, missing extrudates, multiple layers, wrinkles and other suitable user interfaces, as discussed and described herein.

Inspection system 812 can be implement as one or more lines of code stored in a data memory that are loaded into working memory of a processor to cause the processor to be configured to generate user-selectable user interface controls for analysis of inspection data generated by ultrasound inspection system 802, STFT system 804, WSST system 806, inspection data system 808, visualization system 810 and other suitable data. In one example embodiment, inspection system 812 can generate one or more templates to assist a user in selecting a control for accepting or rejecting a tested component, such as to generate control data that causes the tested component to be placed in a suitable container for shipment or further testing, to be returned for rework or for other suitable purposes.

Communications medium 814 can be a data networking medium such as a local area network, a wide area network, a wireless data network, an optical data network or other suitable networks that are configured to allow network components to exchange data and communicate.

FIG. 9 is a diagram of an algorithm 900 for ultrasound data analysis, in accordance with an example embodiment of the present disclosure. Algorithm 900 can be implemented in hardware or a suitable combination of hardware and software.

Algorithm 900 begins at 902, where ultrasound data is generated. In one example embodiment, immersion scanning with a pulse echo setup can be used, or other suitable ultrasound techniques such as those discussed and described herein can also or alternatively be used. The algorithm then proceeds to 904.

At 904, STFT is performed on the ultrasound data to generate STFT data. In one example embodiment, the ultrasound data can be digitized full wave data that is stored in a data file and transmitted to an STFT analysis system over a network or in other suitable manners, as discussed and described further herein. The algorithm then proceeds to 906.

At 906, the STFT data is processed to generate porosity data, as discussed and described herein or in other suitable manners. The algorithm then proceeds to 908.

At 908, porosity visualization data is generated. In one example embodiment, the porosity visualization data can be generated in a user interface to allow a user to select a control to accept a component, to reject a component, or to take other suitable actions. In this example embodiment, the porosity visualization data can be generated at an inspection station of a component manufacturing process, and can include one or more markers to assist an operator with selection of a control that will cause the part to be accepted, rejected, sent back for rework, used for predetermined applications as a function of the material properties of the component or processed in other suitable manners. The algorithm then proceeds to 910.

At 910, it is determined whether the component has been rejected. If it is determined that the component has been rejected, the algorithm proceeds to 912, where a suitable control flag is generated, such as to cause the component to be directed to a predetermined container for rejected parts, to be labelled as rejected or for other suitable automated functions to be performed. Otherwise, the algorithm proceeds to 914 and terminates.

In operation, algorithm 900 allows a component to be automatically inspected using ultrasound to generate ultrasound data that is then transformed into a user interface with one or more user-selectable user interface controls. In this manner, the ultrasound data associated with a particular ultrasound apparatus can be used to transform a component from an unknown state that could potentially include unacceptable physical properties into a known state that is either acceptable or unacceptable. The component can be further transformed by altering its location, packaging, labelling, by reworking the component or by otherwise transforming the component's physical properties. While algorithm 900 is shown as a flow chart, it can also or alternatively be implemented as a state diagram, a ladder diagram, which an object-oriented paradigm or in other suitable, and can be combined with one or more other processes that are performed serially or in parallel.

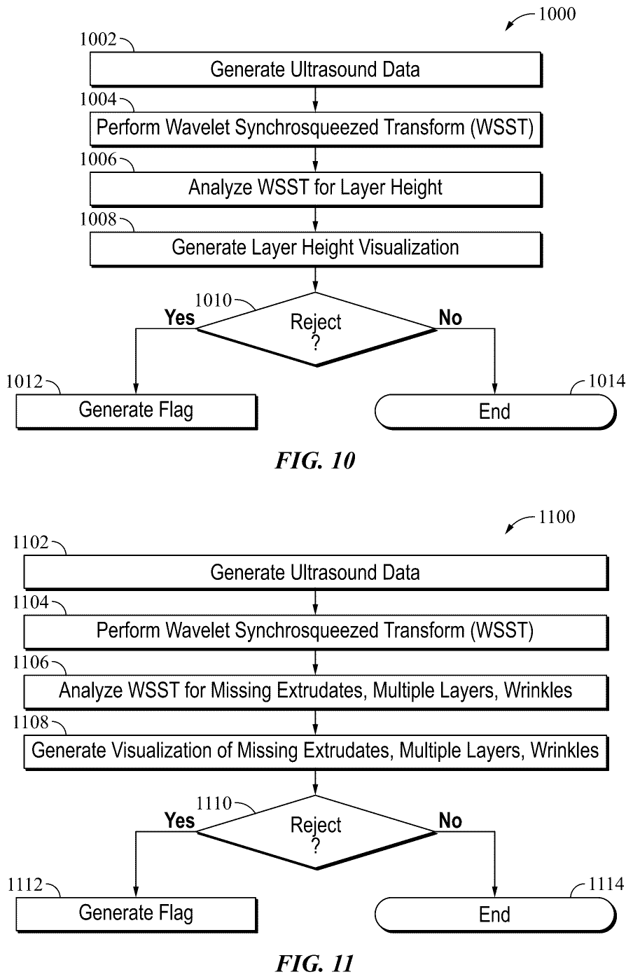

FIG. 10 is a diagram of an algorithm 1000 for ultrasound data analysis for layer height visualization, in accordance with an example embodiment of the present disclosure. Algorithm 1000 can be implemented in hardware or a suitable combination of hardware and software.

Algorithm 1000 begins at 1002, where ultrasound data is generated. In one example embodiment, immersion scanning with a pulse echo setup can be used, or other suitable ultrasound techniques such as those discussed and described herein can also or alternatively be used. The algorithm then proceeds to 1004.

At 1004, perform WSST is performed on the ultrasound data to generate WSST data. In one example embodiment, the ultrasound data can be digitized full wave data that is stored in a data file and transmitted to a WSST analysis system over a network or in other suitable manners, as discussed and described further herein. The algorithm then proceeds to 1006.

At 1006, the WSST data is processed to generate layer height data, as discussed and described herein or in other suitable manners. The algorithm then proceeds to 1008.

At 1008, layer height visualization data is generated. In one example embodiment, the layer height visualization data can be generated in a user interface to allow a user to select a control to accept a component, to reject a component, or to take other suitable actions. In this example embodiment, the layer height visualization data can be generated at an inspection station of a component manufacturing process, and can include one or more markers to assist an operator with selection of a control that will cause the part to be accepted, rejected, sent back for rework, used for predetermined applications as a function of the material properties of the component or processed in other suitable manners. The algorithm then proceeds to 1010.

At 1010, it is determined whether the component has been rejected. If it is determined that the component has been rejected, the algorithm proceeds to 1012, where a suitable control flag is generated, such as to cause the component to be directed to a predetermined container for rejected parts, to be labelled as rejected or for other suitable automated functions to be performed. Otherwise, the algorithm proceeds to 1014 and terminates.

In operation, algorithm 1000 allows a component to be automatically inspected using ultrasound to generate ultrasound data that is then transformed into a user interface with one or more associated user-selectable user interface controls. In this manner, the ultrasound data associated with a particular ultrasound apparatus can be used to transform a component from an unknown state that could potentially include unacceptable physical properties into a known state that is either acceptable or unacceptable. The component can be further transformed by altering its location, packaging, labelling, by reworking the component or by otherwise transforming the component's physical properties. While algorithm 1000 is shown as a flow chart, it can also or alternatively be implemented as a state diagram, a ladder diagram, which an object-oriented paradigm or in other suitable, and can be combined with one or more other processes that are performed serially or in parallel.

FIG. 11 is a diagram of an algorithm 1100 for ultrasound data analysis for visualization of missing extrudates, multiple layers and wrinkles, in accordance with an example embodiment of the present disclosure. Algorithm 1100 can be implemented in hardware or a suitable combination of hardware and software.

Algorithm 1100 begins at 1102, where ultrasound data is generated. In one example embodiment, immersion scanning with a pulse echo setup can be used, or other suitable ultrasound techniques such as those discussed and described herein can also or alternatively be used. The algorithm then proceeds to 1104.

At 1104, perform WSST is performed on the ultrasound data to generate WSST data. In one example embodiment, the ultrasound data can be digitized full wave data that is stored in a data file and transmitted to a WSST analysis system over a network or in other suitable manners, as discussed and described further herein. The algorithm then proceeds to 1106.

At 1106, the WSST data is processed to generate data to identify missing extrudates, multiple layers and wrinkles, as discussed and described herein or in other suitable manners. The algorithm then proceeds to 1108.

At 1108, missing extrudate, multiple layer and wrinkle visualization data is generated. In one example embodiment, the missing extrudate, multiple layer and wrinkle visualization data can be generated in a user interface to allow a user to select a control to accept a component, to reject a component, or to take other suitable actions. In this example embodiment, the missing extrudate, multiple layer and wrinkle visualization data can be generated at an inspection station of a component manufacturing process, and can include one or more markers to assist an operator with selection of a control that will cause the part to be accepted, rejected, sent back for rework, used for predetermined applications as a function of the material properties of the component or processed in other suitable manners. The algorithm then proceeds to 1110.

At 1110, it is determined whether the component has been rejected. If it is determined that the component has been rejected, the algorithm proceeds to 1112, where a suitable control flag is generated, such as to cause the component to be directed to a predetermined container for rejected parts, to be labelled as rejected or for other suitable automated functions to be performed. Otherwise, the algorithm proceeds to 1114 and terminates.

In operation, algorithm 1100 allows a component to be automatically inspected using ultrasound to generate ultrasound data that is then transformed into a user interface with one or more associated user-selectable user interface controls. In this manner, the ultrasound data associated with a particular ultrasound apparatus can be used to transform a component from an unknown state that could potentially include unacceptable physical properties into a known state that is either acceptable or unacceptable. The component can be further transformed by altering its location, packaging, labelling, by reworking the component or by otherwise transforming the component's physical properties. While algorithm 1000 is shown as a flow chart, it can also or alternatively be implemented as a state diagram, a ladder diagram, which an object-oriented paradigm or in other suitable, and can be combined with one or more other processes that are performed serially or in parallel.

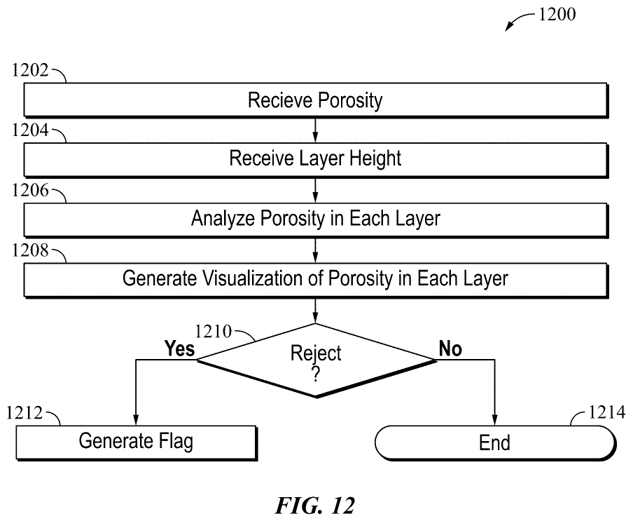

FIG. 12 is a diagram of an algorithm 1200 for ultrasound data analysis for visualization of porosity in separate layers, in accordance with an example embodiment of the present disclosure. Algorithm 1200 can be implemented in hardware or a suitable combination of hardware and software.

Algorithm 1200 begins at 1202, where porosity data is received. The algorithm then proceeds to 1204.

At 1204, layer height data is received. The algorithm then proceeds to 1206.

At 1206, the porosity data and layer height data is analyzed to generate data defining a porosity of each layer. The algorithm then proceeds to 1208.

At 1208, porosity visualization data for each layer is generated. In one example embodiment, the porosity visualization data for each layer can be generated in a user interface to allow a user to select a control to accept a component, to reject a component, or to take other suitable actions. In this example embodiment, the porosity visualization data for each layer can be generated at an inspection station of a component manufacturing process, and can include one or more markers to assist an operator with selection of a control that will cause the part to be accepted, rejected, sent back for rework, used for predetermined applications as a function of the material properties of the component or processed in other suitable manners. The algorithm then proceeds to 1210.

At 1210, it is determined whether the component has been rejected. If it is determined that the component has been rejected, the algorithm proceeds to 1212, where a suitable control flag is generated, such as to cause the component to be directed to a predetermined container for rejected parts, to be labelled as rejected or for other suitable automated functions to be performed. Otherwise, the algorithm proceeds to 1214 and terminates.

In operation, algorithm 1200 allows a component to be automatically inspected using ultrasound to generate ultrasound data that is then transformed into a user interface with one or more associated user-selectable user interface controls. In this manner, the ultrasound data associated with a particular ultrasound apparatus can be used to transform a component from an unknown state that could potentially include unacceptable physical properties into a known state that is either acceptable or unacceptable. The component can be further transformed by altering its location, packaging, labelling, by reworking the component or by otherwise transforming the component's physical properties. While algorithm 1000 is shown as a flow chart, it can also or alternatively be implemented as a state diagram, a ladder diagram, which an object-oriented paradigm or in other suitable, and can be combined with one or more other processes that are performed serially or in parallel.

This disclosure focuses on the ultrasonic inspection of FFF manufactured samples and of CFRP laminates and introducing analysis methods that involved time-frequency transforms including the STFT and the WSST. The features inspected in FFF manufactured samples are of interest due to their effect on the mechanical performance and final quality of components, for layer height, and for missing extrudate. The new method for CFRP laminate wrinkle visualization is a new step leading to better characterizations of a feature that heavily impacts part performance.

The use of the STFT for the detection of inter-bead porosity on FFF manufactured samples is disclosed. The analysis method presented was found to show a strong correlation between the change in porosity and the measured exponential coefficient. Generally, the exponential coefficient increased as porosity increased, which was expected as that would indicate higher frequencies increasing in attenuation compared to lower frequencies at a greater rate. While it is difficult to clearly distinguish small changes in porosity (less than a 1.5% change in porosity), with was possible to easily distinguish between a sample with a 2.61% change in porosity and a sample with a 1.03% change in porosity as the exponential coefficients, which were 0.281 s⁻¹ and 0.150 s⁻¹ respectively, had a large enough difference that it was easy to distinguish the samples in FIG. 3. This is an improvement on previous literature as the changes in porosity considered are much smaller (all within a 3% change in porosity) compared to results from other literature that considered changes in extrusion multiplier of at least 0.10 (e.g., a change in the extrusion multiplier from 1.00 to 0.90), which would indicate greater changes in porosity that was considered in the present study. However, it is important to note that the frequency range considered for analysis, 0-50 MHz, considers frequencies well beyond the upper −6 dB bandwidth of the transducer used for inspection, 6 MHz. As such, it would be prudent for future studies to consider other transducer frequencies to see if the correlation observed between exponential coefficient and change in porosity is consistent under different circumstances.

The quantification of layer height in FFF manufactured samples using a novel analysis method that utilizes the WSST to track the dominant frequency of an ultrasonic signal is also disclosed. An equation for determining layer height based on frequency was introduced (see Equation 3.2). The dominant frequency was used to determine the layer height in a sample with a singular layer height with a maximum percent error of 6.06%. The need for a harmonic factor due to layer height harmonics was discussed. A harmonic factor is necessary as frequencies that are off from the base frequency, where the harmonic factor, n, is set to 1, by a factor of 2⁻⁽ⁿ⁻¹⁾ can also present with high energy, and if the harmonic frequency is closer to, but not far above, the frequency of the transducer than the base frequency then the harmonic factor should be used in calculations to keep them accurate. This also indicates that there is a need for having a close estimate of the true layer height for the correct harmonic factor to be chosen and for accurate measurements to be made.

Samples with two layer heights present were inspected and the layer heights were measured in the first and second regions of the samples with maximum percent errors of 5.07% and 5.86% respectively. The layer height measurements of the first region of the LH_var_0.35_0.2 sample revealed how layer height harmonics can affect the measurement of double layer height samples as the harmonic factor may need to be different for one region that it is for the other for accurate calculations to be performed. It was noted that there is a limitation in the method that is present in a scan of LH_var_0.25_0.2 in which the original ultrasonic signal attenuated beyond an effective level for accurate layer height measurements to be made of the 0.2 mm region of the sample.

The layer height was also presented as a function of depth by using the moving mean of the frequency ridge and calculating the associated layer height as a function of depth using Equation 3.2. This method showed some promise, but revealed that double layer height samples have ringing following the end of the first region that prevents an accurate determination of the boundary between the two layer height regions.

It was also found that the layer height measurements from the CT scan closely matched values measured using the method for measuring the layer heights present in samples with two layer heights that is introduced in this disclosure. The CT scan presented percentage errors of at most 3.29% when considering the averages over each region of the sample. The largest percentage difference between the results from the CT scan and frequency-based measurement method is 5.17% which shows good agreement between the two measurement methods. Overall, the method introduced in this work for measuring layer height shows promise and has the potential to be expanded upon greatly.

The visualization of missing extrudates in FFF manufactured samples by isolating frequencies associated with missing extrudates is also disclosed. As was discussed, all three samples that were inspected had an obvious visual indication when frequencies between 3.55 and 3.8 MHz were isolated. The maximum percentage error of the estimated depth of the missing extrudates is 11.43%. The depth measurements were crude and thus could be improved upon greatly. However, with the measurements available, there is potential shown for the proposed method to be expanded upon for not only identifying and visualizing missing extrudates, but also locating their depth. Overall, the method presented in this work shows that isolating frequencies from the ridge pulled from the WSST shows promise in visualizing a missing extrudate in an FFF printed sample.

The visualization of multiple layers in a CFRP laminate containing out-of-plane wrinkles is also disclosed. Wrinkles can be visualized in the CFRP laminate sample that was inspected for this work. Two scans from the same sample were considered and both could be used to digitally reconstruct and visualize the wrinkle. Both scans lined up will with the ultrasonic b-scan indicating that the sample was digitally reconstructed accurately in the layer above the cross tows inserted in the sample, which were present to cause the wrinkle. The reconstruction past the cross tows was inconsistent at best, but the wrinkle could be well visualized in layers 4 to 13, which are all of the layers, except for the first 3, above the cross tows.

Additional work in the area of inter-bead porosity characterization in FFF could focus on testing the method with other transducer frequencies and a wider range of porosities. Expanding on the current work would further validate its potential for use in characterizing porosity.

Improving porosity measurement methods using tools such as computed tomography (CT) and VolumeGraphics software that could non-destructively determine the porosity levels so that results from ultrasonic inspections could be compared to the true porosity content.

An investigation in use of a time-frequency transform with different resolution capabilities, such as the CWT or WSST or other time-frequency transforms could also be investigated as there is a wide variety. The short-time Fourier transform is very limited in resolution as there is a trade-off between time resolution and frequency resolution that makes it especially difficult to differentiate between lower frequencies when the window length is on the smaller side. This trade-off is addressed by transforms like the CWT and WSST due to their dynamic time-frequency resolution. It is possible other transforms would improve the ability to characterize inter-bead porosity in FFF components.

### Layer Height Quantification in Fused Filament Fabrication

The area of layer height quantification in FFF is disclosed. Use of time corrected gain during data collection is contemplated. The frequency magnitude tends to attenuate beyond a detectable value once the signal dies out. Applying a time corrected gain would alleviate this issue and allow for layer height quantification deeper in to the component. It could potentially improve layer height measurements in samples with multiple layer heights as the later regions would be more easily inspectable, and therefore measurable.

The ringing that occurred in the samples with two layer heights makes the detection of the transition between layer heights difficult to determine based on the layer height as a function of depth. If this ringing could be somehow reduced or the cause of it determined it could go a long way to developing the ability to measure layer height as a function of depth rather than having to determine separate analysis regions of each layer height region.

Layer height harmonics could be evaluated by performing inspections with a greater range of transducer frequencies such as 10, 15, and 20 MHz transducers. This should allow for the detection of layer height harmonics associated with harmonic factors less than 0.

### Missing Extrudate in Fused Filament Fabrication

The area of missing extrudate visualization in fused filament fabrication could be performed by isolating the visualized missing extrudate and perform size and location measurements. This would involve first identifying the largest indication in a missing extrudate point cloud. Once that region, which should be associated with the missing extrudate, is isolated with an automated algorithm, the average width (in the x₁-x₂ plane) of the missing extrudate region could be found based on the region. Again, an algorithm could be written to automatically measure the width of the isolated region. Also, the measurement of the depth of the missing extrudate could be automated as well. This would characterize the missing extrudate well.

A second area of focus would be to investigate the frequency range used for extracting the missing extrudate. It is possible that the region could be optimized or is dependent on other parameters. Considering samples made with other materials or different layer heights would quickly expand the understanding of the frequency range.

### Wrinkles in Carbon Fiber Reinforced Polymer Laminates

The area of out-of-plane wrinkle visualization in carbon fiber reinforced polymer laminates could also be used to test this method with a wider range of samples. With the one sample and two scans the method showed promise, but to be shown to be effective, more samples would need to be used to validate it. The current sample is made from woven carbon fiber fabric, but future work could also consider if this method could work for unidirectional CFRP laminates.

The second area of focus would be to automatically characterize the wrinkle in every layer visualized in the current method. This would allow for defining a wrinkle as a function of depth in the part. This could then be used with models to better estimate the effect a wrinkle will have on part performance.

An extension of the previous area of focus would be to determine a function that best fits the shape of the true wrinkle. That function, for each layer, could then be used to produce finite element models of CFRP laminates with true wrinkles. This could greatly improve the ability to approximate part performance of real components.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

The following references are hereby incorporated by reference for all purposes, as if set forth herein in their entireties.

### BIBLIOGRAPHY

Schmerr Jr., L., 2016, “First Edition Preface,” Fundamentals of Ultrasonic Nondestructive Evaluation: A Modeling Approach, Springer.
Schmerr Jr., L., 2016, “Chapter 1: An Ultrasonic System,” Fundamentals of Ultrasonic Nondestructive Evaluation: A Modeling Approach, Springer.
García-Martínez, H., Ávila-Navarro, E., Torregrosa-Penalva, G., Rodríguez-Martínez, A., Blanco-Angulo, C., & de la Casa-Lillo, M. (2020). Low-cost additive manufacturing techniques applied to the design of planar microwave circuits by fused deposition modeling. Polymers, 12(9), 1946.
Jin, Y., Walker, E., Heo, H., Krokhin, A., Choi, T. Y., & Neogi, A. (2020). Nondestructive ultrasonic evaluation of fused deposition modeling based additively manufactured 3D-printed structures. Smart Materials and Structures, 29(4), 045020.
Na, J. K., & Oneida, E. K. (2018). Nondestructive evaluation method for standardization of fused filament fabrication based additive manufacturing. Additive Manufacturing, 24, 154-165.
Fayazbakhsh, K., Honarvar, F., Amini, H., & Varvani-Farahani, A. (2021). High frequency phased array ultrasonic testing of thermoplastic tensile specimens manufactured by fused filament fabrication with embedded defects. Additive Manufacturing, 47, 102335.
Caminero, M. A., García-Moreno, I., Rodríguez, G. P., & Chacón, J. M. (2019). Internal damage evaluation of composite structures using phased array ultrasonic technique: Impact damage assessment in CFRP and 3D printed reinforced composites. Composites Part B: Engineering, 165, 131-142.
Machado, M. A., Inácio, P. L., Santos, R. A., Gomes, A. F., Martins, A. P., Carvalho, M. S., & Santos, T. G. (2019). Inspection of composite parts produced by additive manufacturing: air-coupled ultrasound and thermography. In 58th Annual British Conference on Non-Destructive Testing. Telford, UK.
Lee, J., Hasanian, M., Saboonchi, H., Baechle, M., & Taheri, H. (2020, April). Ultrasonic evaluation of polymer additively manufactured parts for defect inspection and structural integrity assessment. In Nondestructive Characterization and Monitoring of Advanced Materials, Aerospace, Civil Infrastructure, and Transportation XIV (Vol. 11380, p. 113801Q). International Society for Optics and Photonics.
Koskelo, E. C., & Flynn, E. B. (2016, April). Scanning laser ultrasound and wavenumber spectroscopy for in-process inspection of additively manufactured parts. In Nondestructive Characterization and Monitoring of Advanced Materials, Aerospace, and Civil Infrastructure 2016 (Vol. 9804, p. 980418). International Society for Optics and Photonics.
Yap, Y. L., Toh, W., Koneru, R., Lin, K., Yeoh, K. M., Lim, C. M., . . . & Zheng, G. (2019). A non-destructive experimental-cum-numerical methodology for the characterization of 3D-printed materials-polycarbonate-acrylonitrile butadiene styrene (PC-ABS). Mechanics of Materials, 132, 121-133.
BAGHERI-BAMI, A., & HONARVAR, F. Characterization of Polymer Additive Manufacturing Components by Ultrasonic Testing.
Quintana, J. L. C., Redmann, A., Capote, G. A. M., Pérez-Irizarry, A., Bechara, A., Osswald, T. A., & Lakes, R. (2019). Viscoelastic properties of fused filament fabrication parts. Additive Manufacturing, 28, 704-710.
Jin, Y., Yang, T., Heo, H., Krokhin, A., Shi, S. Q., Dahotre, N., . . . & Neogi, A. (2020). Novel 2D dynamic elasticity maps for inspection of anisotropic properties in fused deposition modeling objects. Polymers, 12(9), 1966.
SAJADI, V., HONARVAR, F., & KARI, M. Online Characterization of Polymer Filaments During FDM Additive Manufacturing Process.
van de Werken, N., Tekinalp, H., Khanbolouki, P., Ozcan, S., Williams, A., and Tehrani, M., 2020, “Additively Manufactured Carbon Fiber-Reinforced Composites: State of the Art and Perspective,” Additive Manufacturing, 31, p. 100962.
Hu, C., and Qin, Q.-H., 2020, “Advances in Fused Deposition Modeling of Discontinuous Fiber/Polymer Composites,” Current Opinion in Solid State and Materials Science, 24(5), p. 100867.
Koch, C., Van Hulle, L., and Rudolph, N., 2017, “Investigation of Mechanical Anisotropy of the Fused Filament Fabrication Process via Customized Tool Path Generation,” Additive Manufacturing, 16, pp. 138-145.
Jang, S., Boddorff, A., Jang, D. J., Lloyd, J., Wagner, K., Thadhani, N., and Brettmann, B., 2021, “Effect of Material Extrusion Process Parameters on Filament Geometry and Inter-Filament Voids in as-Fabricated High Solids Loaded Polymer Composites,” Additive Manufacturing, 47, p. 102313.
Weisstein, E. W., “Hanning Function” [Online]. Available: https://mathworld.wolfram.com/. [Accessed: 12 Feb. 2023].
Sayah, N., and Smith, D. E., 2022, “Effect of Process Parameters on Void Distribution, Volume Fraction, and Sphericity within the Bead Microstructure of Large-Area Additive Manufacturing Polymer Composites,” Polymers, 14(23), p. 5107.
Ning, F., Cong, W., Hu, Y., and Wang, H., 2017, “Additive Manufacturing of Carbon Fiber-Reinforced Plastic Composites Using Fused Deposition Modeling: Effects of Process Parameters on Tensile Properties,” Journal of Composite Materials, 51(4), pp. 451-462.
Bardiya, S., Jerald, J., and Satheeshkumar, V., 2021, “The Impact of Process Parameters on the Tensile Strength, Flexural Strength and the Manufacturing Time of Fused Filament Fabricated (FFF) Parts,” Materials Today: Proceedings, 39, pp. 1362-1366.
Coogan, T. J., and Kazmer, D. O., 2020, “Prediction of Interlayer Strength in Material Extrusion Additive Manufacturing,” Additive Manufacturing, 35, p. 101368.
Fang, L., Yan, Y., Agarwal, O., Seppala, J. E., Hemker, K. J., and Kang, S. H., 2020, “Processing-Structure-Property Relationships of Bisphenol-A-Polycarbonate Samples Prepared by Fused Filament Fabrication,” Additive Manufacturing, 35, p. 101285.
Vidakis, N., Petousis, M., Korlos, A., Velidakis, E., Mountakis, N., Charou, C., and Myftari, A., 2021, “Strain Rate Sensitivity of Polycarbonate and Thermoplastic Polyurethane for Various 3D Printing Temperatures and Layer Heights,” Polymers, 13(16), p. 2752.
Brackett, J., Cauthen, D., Condon, J., Smith, T., Gallego, N., Kunc, V., and Duty, C., 2022, “The Impact of Infill Percentage and Layer Height in Small-Scale Material Extrusion on Porosity and Tensile Properties,” Additive Manufacturing, 58, p. 103063.
Butt, J., Bhaskar, R., and Mohaghegh, V., 2022, “Analysing the Effects of Layer Heights and Line Widths on FFF-Printed Thermoplastics,” Int J Adv Manuf Technol, 121(11), pp. 7383-7411.
Rao, P. K., Liu, J. (Peter), Roberson, D., Kong, Z. (James), and Williams, C., 2015, “Online Real-Time Quality Monitoring in Additive Manufacturing Processes Using Heterogeneous Sensors,” Journal of Manufacturing Science and Engineering, 137(6).
García Plaza, E., Núñez López, P. J., Caminero Torija, M. A., and Chacón Muñoz, J. M., 2019, “Analysis of PLA Geometric Properties Processed by FFF Additive Manufacturing: Effects of Process Parameters and Plate-Extruder Precision Motion,” Polymers, 11(10), p. 1581.
Xue, F., Robin, G., Boudaoud, H., Cruz Sanchez, F. A., and Daya, E. M., 2021, “Effect of Process Parameters on the Vibration Properties of PLA Structure Fabricated by Additive Manufacturing,” University of Texas at Austin.
Schuh, G., Bergweiler, G., Lukas, G., Hohenstein, S., and Schenk, J., 2020, “Feature-Based Print Method for Multi-Axis Material Extrusion in Additive Manufacturing,” Procedia CIRP, 93, pp. 85-89.
Pelzer, L., and Hopmann, C., 2021, “Additive Manufacturing of Non-Planar Layers with Variable Layer Height,” Additive Manufacturing, 37, p. 101697.
Fayazbakhsh, K., Movahedi, M., and Kalman, J., 2019, “The Impact of Defects on Tensile Properties of 3D Printed Parts Manufactured by Fused Filament Fabrication,” Materials Today Communications, 18, pp. 140-148.
Khosravani, M. R., Božić, Ž., Zolfagharian, A., and Reinicke, T., 2022, “Failure Analysis of 3D-Printed PLA Components: Impact of Manufacturing Defects and Thermal Ageing,” Engineering Failure Analysis, 136, p. 106214.
Xie, N., Smith, R. A., Mukhopadhyay, S., and Hallett, S. R., 2018, “A Numerical Study on the Influence of Composite Wrinkle Defect Geometry on Compressive Strength,” Materials & Design, 140, pp. 7-20.
Takeda, T., 2018, “Micromechanics Model for Three-Dimensional Effective Elastic Properties of Composite Laminates with Ply Wrinkles,” Composite Structures, 189, pp. 419-427.
Wu, C., Gu, Y., Luo, L., Xu, P., Wang, S., Li, M., and Zhang, Z., 2018, “Influences of In-Plane and out-of-Plane Fiber Waviness on Mechanical Properties of Carbon Fiber Composite Laminate,” Journal of Reinforced Plastics and Composites, 37(13), pp. 877-891.
Minnie, W., 2021, “Ultrasonic Scanning and Analysis,” Nondestructive Evaluation of Out-of-Plane Wrinkles Within Woven Carbon Fiber Reinforced Plastics (CFRP) Using Ultrasonic Detection, pp. 50-79.
Scholl, S., 2021, “Fourier, Gabor, Morlet or Wigner: Comparison of Time-Frequency Transforms.”
Blackman, R. B., and Tukey, J. W., 1958, “The Measurement of Power Spectra from the Point of View of Communications Engineering—Part I,” The Bell System Technical Journal, 37(1), pp. 185-282.
“Morlet Wavelet MATLAB Morlet” [Online]. Available: https://www.mathworks.com/help/wavelet/ref/morlet.html. [Accessed: 13 Feb. 2023].
“Scale to Frequency MATLAB Scal2frq” [Online]. Available: https://www.mathworks.com/help/wavelet/ref/scal2frq.html. [Accessed: 13 Feb. 2023].
Daubechies, I., Lu, J., and Wu, H.-T., 2011, “Synchrosqueezed Wavelet Transforms: An Empirical Mode Decomposition-like Tool,” Applied and Computational Harmonic Analysis, 30(2), pp. 243-261.
Bause, F., Henning, B., Huang, B., and Kunoth, A., 2013, “Ultrasonic Waveguide Signal Decomposition Using the Synchrosqueezed Wavelet Transform for Modal Group Delay Computation,” 2013 IEEE International Ultrasonics Symposium (IUS), pp. 671-674.
Zhang, Z., Guo, S., Li, Q., Cui, F., Malcolm, A. A., Su, Z., and Liu, M., 2020, “Ultrasonic Detection and Characterization of Delamination and Rich Resin in Thick Composites with Waviness,” Composites Science and Technology, 189, p. 108016.
Zhang, Z., Liu, M., Li, Q., and Png, M., 2020, “Baseline-Free Defect Evaluation of Complex-Microstructure Composites Using Frequency-Dependent Ultrasound Reflections,” Composites Part A: Applied Science and Manufacturing, 139, p. 106090.
Liu, Z., Lin, B., Liang, X., and Du, A., 2021, “Synchrosqueezed Wavelet Transform-Based Method for Characterizing the Dispersive Nature of Laser-Excited Surface Acoustic Waves Propagating through the Coated or Damaged Medium,” Measurement, 185, p. 109965.
Hu, S., Shi, W., Lu, C., Chen, Y., Chen, G., and Shen, G., 2021, “Rapid Detection of Cracks in the Rail Foot by Ultrasonic B-Scan Imaging Using a Shear Horizontal Guided Wave Electromagnetic Acoustic Transducer,” NDT & E International, 120, p. 102437.
Lu, S., Dong, H., and Yu, H., 2021, “Interlaminar Damage Assessment Method of CFRP Laminate Based on Synchrosqueezed Wavelet Transform and Ensemble Principal Component Analysis,” Composite Structures, 276, p. 114581.
Tary, J. B., van der Baan, M., and Herrera, R. H., 2017, “Attenuation Estimation Using High Resolution Time-Frequency Transforms,” Digital Signal Processing, 60, pp. 46-55.
Wiciak, P., Cascante, G., and Polak, M. A., 2021, “Novel Application of Wavelet Synchrosqueezed Transform (WSST) in Laser-Vibrometer Measurements for Condition Assessment of Cementitious Materials,” NDT & E International, 120, p. 102424.
Essentium, “Essentium PCTG Technical Data Sheet,” [Online]. Available: https://essentium.com/wp-content/uploads/2020/08/TDS-Essentium-PCTG_v1.0-Minus-3D.pdf [Accessed: 17 Oct. 2022].
ASTM D792-20, 2020 “Standard Test Methods for Density and Specific Gravity (Relative Density) of Plastics by Displacement,” ASTM International, West Conshohocken, P A, 2010, DOI: 10.1520/D0792-20, www.astm.org
Al-Maharma, A. Y., Patil, S. P., and Markert, B., 2020, “Effects of Porosity on the Mechanical Properties of Additively Manufactured Components: A Critical Review,” Mater. Res. Express, 7(12), p. 122001.
Blackman, N., 2021, “Ply Orientation,” Evaluation of Carbon Fiber Laminates via the Use of Pulse-Echo Ultrasound to Quantify Ply-Stack Orientation and Manufacturing Defects, pp. 62-111.
Jeong, H., and Hsu, D. K., 1995, “Experimental Analysis of Porosity-Induced Ultrasonic Attenuation and Velocity Change in Carbon Composites,” Ultrasonics, 33(3), pp. 195-203.
Blackman, N., 2021, “Foreign Object Detection,” Evaluation of Carbon Fiber Laminates via the Use of Pulse-Echo Ultrasound to Quantify Ply-Stack Orientation and Manufacturing Defects, pp. 112-166.
Zach, 2021, “How to Find the Average of Several Standard Deviations,” Statology.
“Nondestructive Evaluation Techniques: Ultrasound” [Online]. Available: https://www.nde-ed.org/NDETechniques/Ultrasonics/MeasurementTech/velocitymeasure.xhtml. [Accessed: 12 Feb. 2023].
“8.1 DAC and TVG|Olympus IMS” [Online]. Available: https://www.olympus-ims.com/en/ndt-tutorials/flaw-detection/dac-tvg/. [Accessed: 12 Feb. 2023].

What is claimed is:

1. A method for ultrasonic inspection, comprising:
generating ultrasonic inspection data of a component;
receiving the ultrasonic inspections data at a processor configured to perform the steps of:
performing a short-time Fourier transform (STFT) on the ultrasonic inspection data to generate STFT data;
performing a wavelet synchrosqueezed transform (WSST) on the ultrasonic inspection data to generate WSST data;
generating a user interface with a visualization of the STFT data and WSST data on a user interface and one or more user-selectable controls; and
receiving a user-entered selection of the user-selectable controls to accept or reject the component as a function of one or more predetermined indicators associated with the STFT data and one or more predetermined indicators associated with the WSST data.

2. The method of claim 1 wherein generating the user interface with the visualization of the STFT data and WSST data comprises generating the user interface with a visualization of porosity data.

3. The method of claim 1 wherein generating the user interface with the visualization of the STFT data and WSST data comprises generating the user interface with a visualization of layer height data.

4. The method of claim 1 wherein generating the user interface with the visualization of the STFT data and WSST data comprises generating the user interface with a visualization of missing extrudate data.

5. The method of claim 1 wherein generating the user interface with the visualization of the STFT data and WSST data comprises generating the user interface with a visualization of laminate wrinkle data.

6. The method of claim 1 wherein the component is a fused filament fabrication component.

7. The method of claim 1 wherein the component is a fiber reinforced laminate component.

8. A method for detection of inter-bead porosity of a component comprising:
generating ultrasound data using a transducer having a predetermined bandwidth;
receiving the ultrasound data at a processor configured to perform the steps of:
measuring a change in porosity of the component using the ultrasound data;
generating an exponential coefficient of the ultrasound data of the component;
determining whether a strong correlation exists between the change in porosity and the exponential coefficient; and
receiving user-entered control data to accept the component if it has low porosity.

9. The method of claim 8 wherein determining whether the strong correlation exists between the change in porosity and the exponential coefficient comprises determining whether the exponential coefficient increased at a greater rate as porosity increased at higher frequencies as compared to lower frequencies.

10. The method of claim 8 wherein determining whether the strong correlation exists between the change in porosity and the exponential coefficient comprises determining whether the exponential coefficient increased at a greater rate as porosity increased at higher frequencies as compared to lower frequencies, over a predetermined frequency range.

11. The method of claim 8 wherein determining whether the strong correlation exists between the change in porosity and the exponential coefficient comprises determining whether the exponential coefficient increased at a predetermined rate.

12. The method of claim 8 wherein determining whether the strong correlation exists between the change in porosity and the exponential coefficient comprises determining whether the exponential coefficient increased as porosity increased.

13. The method of claim 8 wherein determining whether the strong correlation exists between the change in porosity and the exponential coefficient comprises determining whether the exponential coefficient increased at higher frequencies as compared to lower frequencies.

14. A method for quantification of layer height in a component, comprising:
generating ultrasonic data of the component;
receiving the ultrasonic data at a processor configured to perform the steps of:
performing a wavelet synchrosqueezed transform (WSST) of the ultrasonic data to generate WSST data;
identifying a dominant frequency of the ultrasonic signal using the WSST data;
determining layer height based on the dominant frequency;
generating a user interface displaying the layer height and one or more user-selectable controls; and
receiving a user-entered selection of the user-selectable controls to accept or reject the component as a function of one or more predetermined indicators associated with the layer height.

15. The method of claim 14 further comprising identifying a harmonic factor instead of the dominant frequency of the ultrasonic signal to determine layer height.

16. The method of claim 14 wherein the component is a fused filament fabrication.

17. The method of claim 14 wherein determining the layer height based on the dominant frequency is performed using Equation (3.2).

18. The method of claim 14 wherein the layer height is determined as a function of depth.

19. The method of claim 18 wherein the layer height is determined by using a moving mean of a frequency ridge.

20. The method of claim 14 wherein determining the layer height based on the dominant frequency is performed at a predetermined time.
